(19) United States
(12) Patent Application Publication
(10) Pub. No.: US 2026/0019550 A1
(43) Pub. Date: Jan. 15, 2026

(54) ELECTRONIC DEVICE, METHOD, AND COMPUTER-READABLE STORAGE MEDIUM FOR DISPLAYING SCREEN CORRESPONDING TO SIZE OF EXTERNAL OBJECT ON DISPLAY

(71) Applicant: Samsung Electronics Co., Ltd., Suwon-si (KR)

(72) Inventors: Eunkyung LEE, Suwon-si (KR); Harin MOON, Suwon-si (KR); Wanje PARK, Suwon-si (KR)

(21) Appl. No.: 19/338,687

(22) Filed: Sep. 24, 2025

Related U.S. Application Data
(63) Continuation of application No. PCT/KR2024/095403, filed on Feb. 19, 2024.

(30) Foreign Application Priority Data
Apr. 11, 2023 (KR) 10-2023-0047852
May 12, 2023 (KR) 10-2023-0061746

(51) Int. Cl. H04N 13/279; H04N 13/139; H04N 13/293; H04N 13/344

(52) U.S. Cl. CPC H04N 13/279; H04N 13/139; H04N 13/293; H04N 13/344

(57) ABSTRACT

A processor of an electronic device, may be configured to cause the electronic device to: display, within a three-dimensional image, a first screen having a size provided by a software application, based on the type of the software application being a first type, display, within the three-dimensional image, a second screen having a size, based on the type of the software application being a second type, of a visual object included in a frame image acquired via a camera and identified based on a positional relationship between the electronic device and an external display. The disclosure may relate to a metaverse service for strengthening interconnectivity between real objects and virtual objects. For example, the metaverse service may be provided over a network based on fifth generation (5G) and/or sixth generation (6G).

### CROSS-REFERENCE TO RELATED APPLICATIONS

This application is a continuation of International Application No. PCT/KR2024/095403 designating the United States, filed on Feb. 19, 2024, in the Korean Intellectual Property Receiving Office and claiming priority to Korean Patent Application Nos. 10-2023-0047852, filed on Apr. 11, 2023, and 10-2023-0061746, filed on May 12, 2023, in the Korean Intellectual Property Office, the disclosures of each of which are incorporated by reference herein in their entireties.

### BACKGROUND

### Field

A disclosure relates to an electronic device, a method, and a non-transitory computer readable storage medium for displaying a screen corresponding to a size of an external object on a display.

### Description of Related Art

In order to provide enhanced user experience, an electronic device providing an augmented reality (AR) service that displays information generated by a computer in connection with an external object in a real world is being developed. The electronic device may be an electronic device that may be worn by a user. For example, the electronic device may be AR glasses and/or a head-mounted device (HMD).

### SUMMARY

In an electronic device according to an example embodiment, the electronic device may include: a display, a camera, and at least one processor, comprising processing circuitry, individually and/or collectively may be configured to cause the electronic device to: while displaying a frame image obtained through the camera, receive an input for executing a software application; in response to the input, initiate execution of the software application to display, on the display, a three-dimensional image; based on a type of the executed software application being a first type, display, within the three-dimensional image, a first screen having a size provided by the software application; and based on the type being a second type, display, within the three-dimensional image, a second screen having a size of a visual object included in the frame image and identified based on a positional relationship between the electronic device and an external display.

In a method performed by an electronic device according to an example embodiment, the method may include: while displaying a frame image obtained through a camera, receiving an input for executing a software application; in response to the input, initiating execution of the software application to display, on a display, a three-dimensional image; based on a type of the executed software application being a first type, displaying, within the three-dimensional image, a first screen having a size provided by the software application; and based on the type being a second type, displaying, within the three-dimensional image, a second screen having a size of a visual object included in the frame image and identified based on a positional relationship between the electronic device and an external display.

In a non-transitory computer-readable storage medium storing one or more programs according to an example embodiment, the one or more programs may include instructions which, when executed by at least one processor, comprising processing circuitry, of an electronic device including a display and a camera individually or collectively, causing the electronic device to perform operations including: while displaying a frame image obtained through the camera, receiving an input for executing a software application; in response to the input, initiating execution of the software application to display, on the display, a three-dimensional image; based on a type of the executed software application being a first type, displaying, within the three-dimensional image, a first screen having a size provided by the software application; and based on the type being a second type, displaying, within the three-dimensional image, a second screen having a size of a visual object included in the frame image and identified based on a positional relationship between the electronic device and an external display.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example state of identifying an input indicating an entry into a virtual space while an electronic device identifies an external display using a camera according to various embodiments;

FIG. 2A is a perspective view of an example electronic device according to various embodiments;

FIG. 2B is a perspective view illustrating example hardware disposed in an electronic device according to various embodiments;

FIGS. 3A and 3B are perspective views illustrating an exterior of an example electronic device according to various embodiments;

FIG. 4 is a block diagram illustrating an example configuration of an electronic device according to various embodiments;

FIG. 5 is a flowchart illustrating an example operation of an electronic device according to various embodiments;

FIGS. 6A and 6B are diagrams illustrating an example operation of an electronic device to display at least a portion of a virtual space according to various embodiments;

FIGS. 7A, 7B and 7C are diagrams illustrating an example operation in which an electronic device displays a screen based on a size of an external display according to various embodiments;

FIGS. 8A, 8B and 8C are diagrams illustrating an example operation in which an electronic device adjusts a size of a screen displayed on a display according to various embodiments;

FIG. 9 is a flowchart illustrating an example operation of an electronic device according to various embodiments;

FIG. 10 is a diagram illustrating an example operation in which an electronic device displays a screen corresponding to at least one of a plurality of external displays according to various embodiments;

FIG. 11 is a diagram illustrating an example operation in which an electronic device displays a plurality of screens according to various embodiments;

FIG. 12 is a diagram illustrating an example operation in which an electronic device displays a screen according to various embodiments;

FIG. 13 is a diagram illustrating an example operation in which an electronic device guides a position change of a user according to various embodiments;

FIG. 14 is a diagram illustrating an example operation in which an electronic device identifies a touch input according to various embodiments;

FIG. 15 is a flowchart illustrating an example operation of an electronic device according to various embodiments;

FIG. 16 is a diagram illustrating an example network environment in which a metaverse service is provided through a server according to various embodiments; and

FIG. 17 is a block diagram illustrating an example electronic device within a network environment according to various embodiments.

### DETAILED DESCRIPTION

Hereinafter, various example embodiments of the disclosure will be described in greater detail with reference to the accompanying drawings.

The various example embodiments of the present disclosure and terms used herein are not intended to limit the technology described in the present disclosure to specific embodiments, and should be understood to include various modifications, equivalents, or substitutes. In relation to the description of the drawings, a reference numeral may be used for a similar component. A singular expression may include a plural expression unless it is clearly meant differently in the context. In the present disclosure, an expression such as “A or B”, “at least one of A and/or B”, “A, B or C”, or “at least one of A, B and/or C”, and the like may include all possible combinations of items listed together. Expressions such as “1st”, “2nd”, “first” or “second”, and the like may modify the corresponding components regardless of order or importance, is used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

The term “module” used in the present disclosure may include a unit configured with hardware, software, or firmware, and may be used interchangeably with terms such as logic, logic block, component, or circuit, and the like. The module may be an integrally configured component or a minimum unit or part thereof that performs one or more functions. For example, a module may be configured with an application-specific integrated circuit (ASIC).

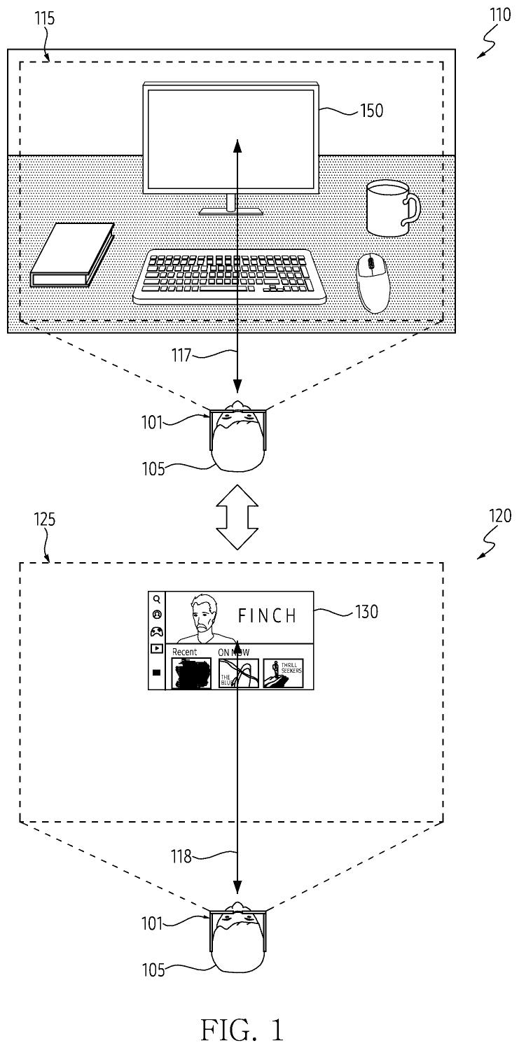

FIG. 1 is a diagram illustrating an example state of identifying an input indicating an entry into a virtual space while an electronic device identifies an external display using a camera according to various embodiments.

An electronic device 101 of FIG. 1 may include a head-mounted display (HMD) wearable on a head of a user 105. The electronic device 101 may be referred to as a wearable device in terms of being wearable on the head of the user 105. The electronic device 101 according to an embodiment may include a camera disposed toward a front of the user 105 in a state of being worn by the user 105. The front of the user 105 may include a direction in which the head of user 105 and/or both eyes included in the head face. The electronic device 101 according to an embodiment may include a sensor for identifying a motion of the head of the user 105 and/or a motion of the electronic device 101 in the state of being worn by the user 105. The electronic device 101 may identify an angle of the electronic device 101 based on data of the sensor. In order to provide a user interface (UI) based on a virtual reality (VR), an augmented reality (AR), and/or a mixed reality (MR) to the user 105 wearing the electronic device 101, the electronic device 101 may control the camera and/or the sensor. The UI may be associated with a metaverse service and/or a notification service provided by the electronic device 101 and/or a server connected to the electronic device 101.

The electronic device 101 according to an embodiment may execute a function associated with the augmented reality (AR) and/or the mixed reality (MR). Referring to FIG. 1, in the state that the user 105 is wearing the electronic device 101, the electronic device 101 may include at least one lens disposed adjacent to an eye of the user 105. The electronic device 101 may couple ambient light passing through the lens with light emitted from a display of the electronic device 101. A display region of the display may be formed in the lens through which the ambient light passes through. Since the electronic device 101 couples the ambient light and the light emitted from the display, the user 105 may see an image in which a real object recognized by the ambient light and a virtual object formed by the light emitted from the display are mixed.

The electronic device 101 according to an embodiment may execute a function associated with a video see-through (VST) and/or the virtual reality (VR). In the state that the user 105 is wearing the electronic device 101, the electronic device 101 may include a housing that covers the eye of the user 105. The electronic device 101 may include a display disposed on a first surface facing the eye in the state. The electronic device 101 may include a camera disposed on a second surface opposite to the first surface. Using the camera, the electronic device 101 may obtain frames in which ambient light is included. The electronic device 101 may enable the user 105 to recognize the ambient light through the display by outputting the frames to the display disposed on the first surface. A display region of the display disposed on the first surface may be formed by one or more pixels included in the display. The electronic device 101 may enable the user 105 to recognize a virtual object together with the real object recognized by the ambient light by synthesizing the virtual object in the frames outputted through the display.

The electronic device 101 according to an embodiment may provide a user experience based on the mixed reality (MR) using the virtual space. The electronic device 101 may generate a virtual space mapped to an external space by recognizing the external space in which the electronic device 101 is included. Recognizing the external space by the electronic device 101 may include an operation of obtaining information on a size (e.g., a size of the external space divided by a side wall, a bottom surface, and/or a ceiling surface) of the external space. Recognizing the external space by the electronic device 101 may include an operation of identifying a region (e.g., a ceiling and/or a bottom) included in the external space. The operation of identifying the external space by the electronic device 101 may include an operation of identifying a position of a visual object (e.g., the user interface (UI) for displaying at least one image) to be displayed in the display.

Referring to FIG. 1, in an environment 110, the electronic device 101 according to an embodiment may identify an external display 150 through the camera based on the function associated with the video see-through (VST). Hereinafter, an operation performed by the electronic device 101 may be performed by a processor of the electronic device 101. The electronic device 101 may obtain a frame image 115 corresponding to a real environment (or a real space) 110 around the user 105 and/or the electronic device 101 in a field of view (FoV) of the camera. The electronic device 101 may identify the external display 150 in the environment 110 based on obtaining the frame image 115. An operation of identifying the external display 150 using the frame image 115 obtained through the camera by the electronic device 101 may include an operation of identifying a visual object corresponding to the external display 150 in the frame image 115. For example, the external display 150 may include a television (TV), a personal computer (PC) such as a laptop and a desktop, a smartphone, a smartpad, a tablet PC, a smartwatch, and/or an accessory such as a monitor.

For example, the electronic device 101 may receive an input indicating a display of a three-dimensional image 125 based on displaying the frame image 115 on the display. The input may include an input for switching from a display of a frame image corresponding to a reality environment (e.g., the environment 110) to a display of a three-dimensional image corresponding to a virtual environment (e.g., an environment 120). The input may include an input indicating an entry into the virtual environment. However, the disclosure is not limited thereto.

For example, the electronic device 101 may display the three-dimensional image 125 corresponding to the FoV based on a direction of the electronic device 101 on the display in the environment 120 corresponding to the virtual space. Based on displaying the three-dimensional image 125 on the display, the external display 150 included in the frame image 115 may not be identified by a user. As an example, the electronic device 101 may display a screen 130 corresponding to the external display 150 in the environment 120, and display an image corresponding to at least a portion of the virtual space in another portion different from a portion where the screen 130 is displayed. As an example, the other portion may be a portion in which an image corresponding to external objects is formed by reflected light from the external objects included in the environment 110. However, the disclosure is not limited to the example described above.

For example, the three-dimensional image 125 may refer, for example, to an image corresponding to at least a portion of the virtual space. The three-dimensional image 125 may be obtained based on a software application providing a virtual reality service. The three-dimensional image 125 may vary according to a type of the software application.

For example, the type of the software application may be identified based on an application (e.g., App Store or Play Store™) used to install a software application in the electronic device 101. The type of the software application may be identified by manifest information corresponding to the software application. The type of the software application may include business (e.g., a software application that includes a function such as a document editing, an email management, and a remote desktop communication), a book (e.g., a software application that provides an e-book such as a novel and a cartoon), music (e.g., a software application that provides audio information such as music and a radio), a navigation (e.g., a software application that provides a service to assist a vehicle driving), a game, a video, entertainment (e.g., a software application that provides a service such as a movie and a video content), a social network, and the like.

For example, the electronic device 101 may identify a multimedia software application and/or a utility software application according to the type of the software application. The multimedia software application may include software applications that provide the service such as the game, the video, the entertainment, and the music. The multimedia software application may be an example of a software application for providing a sense of space of the virtual space to the user of the electronic device 101. The utility software application may include a software application that provides the business, the book, and the service. However, the disclosure is not limited thereto. As an example, the electronic device 101 may change at least one software application corresponding to the utility software application to be included in a type corresponding to the multimedia software application.

For example, the electronic device 101 may identify the type of the software application based on receiving the input indicating the display of the three-dimensional image 125. The electronic device 101 may receive the input indicating execution of the software application for the display of the three-dimensional image 125. Based on receiving the input, the electronic device 101 may initiate the display of the three-dimensional image 125 by replacing the display of the frame image 115. The electronic device 101 may temporarily cease the display of the frame image 115 for the display of the three-dimensional image 125. Based on temporarily ceasing the display of the frame image 115, the electronic device 101 may display the three-dimensional image 125 on the display.

For example, the electronic device 101 may identify the type of the software application that has initiated execution to display the three-dimensional image 125. The electronic device 101 may identify a positional relationship between the electronic device 101 and the external display 150 based on identifying the type of the software application. The positional relationship may include a distance 117 between the electronic device 101 and the external display 150, and a relative position or a direction of the external display 150 with respect to the electronic device 101. The positional relationship may be obtained based on a sensor in the electronic device 101. The electronic device 101 may identify a size of the external display 150 through the frame image 115 based on identifying the positional relationship. The size may include a width and/or a height of the external display 150. However, the disclosure is not limited thereto. As an example, in a case of identifying a type (e.g., the utility software application) of the software application distinct from a reference type (e.g., the multimedia software application), the electronic device 101 may identify the size of the external display 150.

For example, in a case of identifying a type of the software application corresponding to the reference type, the electronic device 101 may display a screen having a size provided by the software application for displaying the three-dimensional image 125 on the display based on the positional relationship between the electronic device 101 and the external display 150. The size provided by the software application may be different from the size of the external display 150. However, the disclosure is not limited thereto.

For example, in a case of identifying the type (e.g., the utility software application) of the software application distinct from the reference type, the electronic device 101 may display, in the three-dimensional image 125, the screen 130 having the size of the external display 150 through the display based on the positional relationship. The electronic device 101 may display the screen 130 in the three-dimensional image 125 based on a positional relationship of the external display. As the electronic device 101 displays the screen 130 on the display based on the positional relationship, a distance 118 between the screen 130 detected by the user 105 and the electronic device (or the user wearing the electronic device) may be substantially similar to the distance 117.

The electronic device 101 may provide continuity of an operation of switching from the environment 110 (e.g., a real environment) to the environment 120 (e.g., the virtual environment) based on displaying the screen 130 based on the positional relationship.

For example, the screen 130 may refer, for example, to the user interface (UI) displayed in at least a portion of the display. The screen 130 may include, for example, an activity of an Android operating system. In the screen 130, the electronic device 101 may display one or more visual objects. A visual object may refer, for example, to an object deployable in the screen for transmission and/or interaction of information, such as text, an image, an icon, a video, a button, a check box, a radio button, a text box, a slider, and/or a table. The visual object may be referred to as a visual guide, a visual element, a UI element, a view object, and/or a view element.

As described above, in the environment 120 indicating the virtual space, the electronic device 101 according to an embodiment may display the screen 130 based on the size of the external display 150 on the display based on the type of the software application. In order to provide a unity of a reality space and the virtual space to the user, the electronic device 101 may display the screen 130 corresponding to the size of the external display 150 on the display after entering the virtual space based on the size of the external display 150 identified before receiving the input indicating the entry into the virtual space. The electronic device 101 may display the screen 130 in a virtual environment 120 using the size of the external display 150 included in a reality environment 110 in order to reduce a sense of difference between the reality environment 110 and the virtual environment 120.

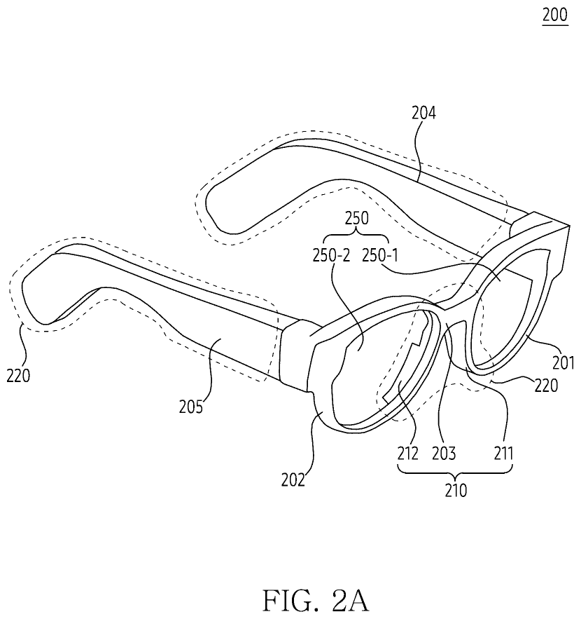

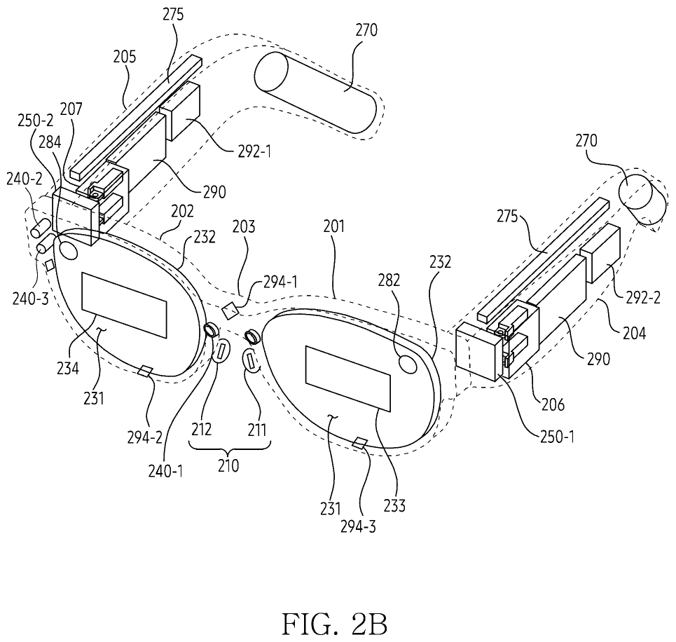

FIG. 2A is a perspective view of an example electronic device according to various embodiments. FIG. 2B is a perspective view illustrating an example of one or more hardware disposed in an electronic device according to various embodiments. An electronic device 200 according to an embodiment may have a form of glasses that are wearable on a user's body part (e.g., head). The electronic device 200 of FIGS. 2A to 2B may be an example of the electronic device 101 of FIG. 1. The electronic device 200 may include a head-mounted display (HMD). For example, a housing of the electronic device 200 may include flexible materials, such as rubber and/or silicone, that have a form in close contact with a part of the user's head (e.g., a part of the face surrounding both eyes). For example, the housing of the electronic device 200 may include one or more straps able to be twined around the user's head and/or one or more temples attachable to the head's car.

Referring to FIG. 2A, according to an embodiment, the electronic device 200 may include at least one display 250 and a frame supporting the at least one display 250.

According to an embodiment, the electronic device 200 may be wearable on a portion of the user's body. The electronic device 200 may provide augmented reality (AR), virtual reality (VR), or mixed reality (MR) combining the augmented reality and the virtual reality to a user wearing the electronic device 200. For example, the electronic device 200 may display a virtual reality image provided from at least one optical device 282 and 284 of FIG. 2B on at least one display 250, in response to a user's preset gesture obtained through a motion recognition camera 240-2 of FIG. 2B.

According to an embodiment, the at least one display 250 may provide visual information to a user. For example, the at least one display 250 may include a transparent or translucent lens. The at least one display 250 may include a first display 250-1 and/or a second display 250-2 spaced apart from the first display 250-1. For example, the first display 250-1 and the second display 250-2 may be disposed at positions corresponding to the user's left and right eyes, respectively.

Referring to FIG. 2B, the at least one display 250 may provide visual information transmitted through a lens included in the at least one display 250 from ambient light to a user and other visual information distinguished from the visual information2. The lens may be formed based on at least one of a fresnel lens, a pancake lens, or a multi-channel lens. For example, the at least one display 250 may include a first surface 231 and a second surface 232 opposite to the first surface 231. A display area may be formed on the second surface 232 of at least one display 250. When the user wears the electronic device 200, ambient light may be transmitted to the user by being incident on the first surface 231 and being penetrated through the second surface 232. For another example, the at least one display 250 may display an augmented reality image in which a virtual reality image provided by the at least one optical device 282 and 284 is combined with a reality screen transmitted through ambient light, on a display area formed on the second surface 232.

According to an embodiment, the at least one display 250 may include at least one waveguide 233 and 234 that transmits light transmitted from the at least one optical device 282 and 284 by diffracting to the user. The at least one waveguide 233 and 234 may be formed based on at least one of glass, plastic, or polymer. A nano pattern may be formed on at least a portion of the outside or inside of the at least one waveguide 233 and 234. The nano pattern may be formed based on a grating structure having a polygonal or curved shape. Light incident to an end of the at least one waveguide 233 and 234 may be propagated to another end of the at least one waveguide 233 and 234 by the nano pattern. The at least one waveguide 233 and 234 may include at least one of at least one diffraction element (e.g., a diffractive optical element (DOE), a holographic optical element (HOE)), and a reflection element (e.g., a reflection mirror). For example, the at least one waveguide 233 and 234 may be disposed in the electronic device 200 to guide a screen displayed by the at least one display 250 to the user's eyes. For example, the screen may be transmitted to the user's eyes based on total internal reflection (TIR) generated in the at least one waveguide 233 and 234.

The electronic device 200 may analyze an object included in a real image collected through a photographing camera 240-3, combine with a virtual object corresponding to an object that becomes a subject of augmented reality provision among the analyzed object, and display on the at least one display 250. The virtual object may include at least one of text and images for various information associated with the object included in the real image. The electronic device 200 may analyze the object based on a multi-camera such as a stereo camera. For the object analysis, the electronic device 200 may execute simultaneous localization and mapping (SLAM)) using an inertial measurement unit (IMU), multi-camera, and/or time-of-flight (ToF). The user wearing the electronic device 200 may watch an image displayed on the at least one display 250.

According to an embodiment, a frame may be configured with a physical structure in which the electronic device 200 may be worn on the user's body. According to an embodiment, a frame may be configured so that when the user wears the electronic device 200, the first display 250-1 and the second display 250-2 may be positioned corresponding to the user's left and right eyes. The frame may support the at least one display 250. For example, the frame may support the first display 250-1 and the second display 250-2 to be positioned at positions corresponding to the user's left and right eyes.

Referring to FIG. 2A, according to an embodiment, the frame may include an area 220 at least partially in contact with the portion of the user's body in case that the user wears the electronic device 200. For example, the area 220 of the frame in contact with the portion of the user's body may include an area in contact with a portion of the user's nose, a portion of the user's car, and a portion of the side of the user's face that the electronic device 200 contacts. According to an embodiment, the frame may include a nose pad 210 that is contacted on the portion of the user's body. When the electronic device 200 is worn by the user, the nose pad 210 may be contacted on the portion of the user's nose. The frame may include a first temple 204 and a second temple 205, which are contacted on another portion of the user's body that is distinct from the portion of the user's body.

For example, the frame may include a first rim 201 surrounding at least a portion of the first display 250-1, a second rim 202 surrounding at least a portion of the second display 250-2, a bridge 203 disposed between the first rim 201 and the second rim 202, a first pad 211 disposed along a portion of the edge of the first rim 201 from one end of the bridge 203, a second pad 212 disposed along a portion of the edge of the second rim 202 from the other end of the bridge 203, the first temple 204 extending from the first rim 201 and fixed to a portion of the wearer's car, and the second temple 205 extending from the second rim 202 and fixed to a portion of the car opposite to the car. The first pad 211 and the second pad 212 may be in contact with the portion of the user's nose, and the first temple 204 and the second temple 205 may be in contact with a portion of the user's face and the portion of the user's car. The temples 204 and 205 may be rotatably connected to the rim through hinge units 206 and 207 of FIG. 2B. The first temple 204 may be rotatably connected with respect to the first rim 201 through the first hinge unit 206 disposed between the first rim 201 and the first temple 204. The second temple 205 may be rotatably connected with respect to the second rim 202 through the second hinge unit 207 disposed between the second rim 202 and the second temple 205. According to an embodiment, the electronic device 200 may identify an external object (e.g., a user's fingertip) touching the frame and/or a gesture performed by the external object using a touch sensor, a grip sensor, and/or a proximity sensor formed on at least a portion of the surface of the frame.

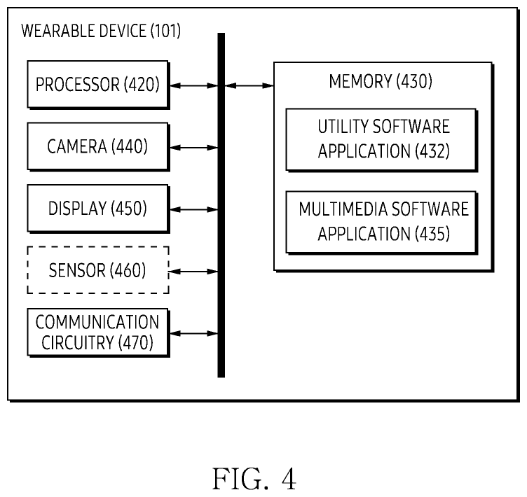

According to an embodiment, the electronic device 200 may include hardware (e.g., hardware to be described later based on the block diagram of FIG. 4) that performs various functions. For example, the hardware may include a battery module 270, an antenna module 275, the at least one optical device 282 and 284, speakers (e.g., speakers 292-1 and 292-2), a microphone (e.g., microphones 294-1, 294-2, and 294-3), a light emitting module (not illustrated), and/or a printed circuit board (PCB) 290 (e.g., printed circuit board). Various hardware may be disposed in the frame.

According to an embodiment, the microphone (e.g., the microphones 294-1, 294-2, and 294-3) of the electronic device 200 may obtain a sound signal, by being disposed on at least a portion of the frame. The first microphone 294-1 disposed on the bridge 203, the second microphone 294-2 disposed on the second rim 202, and the third microphone 294-3 disposed on the first rim 201 are illustrated in FIG. 2B, but the number and disposition of the microphone 294 are not limited to an embodiment of FIG. 2B. In case that the number of the microphone 294 included in the electronic device 200 is two or more, the electronic device 200 may identify a direction of the sound signal using a plurality of microphones disposed on different portions of the frame.

According to an embodiment, the at least one optical device 282 and 284 may project a virtual object on the at least one display 250 in order to provide various image information to the user. For example, the at least one optical device 282 and 284 may be a projector. The at least one optical device 282 and 284 may be disposed adjacent to the at least one display 250 or may be included in the at least one display 250 as a portion of the at least one display 250. According to an embodiment, the electronic device 200 may include a first optical device 282 corresponding to the first display 250-1, and a second optical device 284 corresponding to the second display 250-2. For example, the at least one optical device 282 and 284 may include the first optical device 282 disposed at a periphery of the first display 250-1 and the second optical device 284 disposed at a periphery of the second display 250-2. The first optical device 282 may transmit light to the first waveguide 233 disposed on the first display 250-1, and the second optical device 284 may transmit light to the second waveguide 234 disposed on the second display 250-2.

In an embodiment, a camera 240 may include the photographing camera 240-3, an eye tracking camera (ET CAM) 240-1, and/or the motion recognition camera 240-2. The photographing camera 240-3, the eye tracking camera 240-1, and the motion recognition camera 240-2 may be disposed at different positions on the frame and may perform different functions. The eye tracking camera 240-1 may output data indicating a position of eye or a gaze of the user wearing the electronic device 200. For example, the electronic device 200 may detect the gaze from an image including the user's pupil obtained through the eye tracking camera 240-1. An example in which the eye tracking camera 240-1 is disposed toward the user's right eye is illustrated in FIG. 2B, but the disclosure is not limited thereto, and the eye tracking camera 240-1 may be disposed alone toward the user's left eye or may be disposed toward two eyes.

In an embodiment, the photographing camera 240-3 may photograph a real image or background to be matched with a virtual image in order to implement the augmented reality or mixed reality content. The photographing camera 240-3 may photograph an image of a specific object existing at a position viewed by the user and may provide the image to the at least one display 250. The at least one display 250 may display one image in which a virtual image provided through the at least one optical device 282 and 284 is overlapped with information on the real image or background including an image of the specific object obtained using the photographing camera 240-3. In an embodiment, the photographing camera 240-3 may be disposed on the bridge 203 disposed between the first rim 201 and the second rim 202.

The eye tracking camera 240-1 may implement a more realistic augmented reality by matching the user's gaze with the visual information provided on the at least one display 250, by tracking the gaze of the user wearing the electronic device 200. For example, when the user looks at the front, the electronic device 200 may naturally display environment information associated with the user's front on the at least one display 250 at a position where the user is positioned. The eye tracking camera 240-1 may be configured to capture an image of the user's pupil in order to determine the user's gaze. For example, the eye tracking camera 240-1 may receive gaze detection light reflected from the user's pupil and may track the user's gaze based on the position and movement of the received gaze detection light. In an embodiment, the eye tracking camera 240-1 may be disposed at a position corresponding to the user's left and right eyes. For example, the eye tracking camera 240-1 may be disposed in the first rim 201 and/or the second rim 202 to face the direction in which the user wearing the electronic device 200 is positioned.

The motion recognition camera 240-2 may provide a specific event to the screen provided on the at least one display 250 by recognizing the movement of the whole or portion of the user's body, such as the user's torso, hand, or face. The motion recognition camera 240-2 may obtain a signal corresponding to motion by recognizing the user's motion (e.g., gesture recognition), and may provide a display corresponding to the signal to the at least one display 250. The processor may identify a signal corresponding to the operation and may perform a preset function based on the identification. In an embodiment, the motion recognition camera 240-2 and camera 240-3 may be disposed on the first rim 201 and/or the second rim 202.

The camera 240 included in the electronic device 200 is not limited to the above-described eye tracking camera 240-1 and the motion recognition camera 240-2. For example, the electronic device 200 may identify an external object included in the FoV using a camera 240 disposed toward the user's FoV. The electronic device 200 identifying the external object may be performed based on a sensor for identifying a distance between the electronic device 200 and the external object, such as a depth sensor and/or a time of flight (ToF) sensor. The camera 240 disposed toward the FoV may support an autofocus function and/or an optical image stabilization (OIS) function. For example, in order to obtain an image including a face of the user wearing the electronic device 200, the electronic device 200 may include the camera 240 (e.g., a face tracking (FT) camera) disposed toward the face.

Although not illustrated, the electronic device 200 according to an embodiment may further include a light source (e.g., LED) that emits light toward a subject (e.g., user's eyes, face, and/or an external object in the FoV) photographed using the camera 240. The light source may include an LED having an infrared wavelength. The light source may be disposed on at least one of the frame, and the hinge units 206 and 207.

According to an embodiment, the battery module 270 may supply power to electronic components of the electronic device 200. In an embodiment, the battery module 270 may be disposed in the first temple 204 and/or the second temple 205. For example, the battery module 270 may be a plurality of battery modules 270. The plurality of battery modules 270, respectively, may be disposed on each of the first temple 204 and the second temple 205. In an embodiment, the battery module 270 may be disposed at an end of the first temple 204 and/or the second temple 205.

The antenna module 275 may transmit the signal or power to the outside of the electronic device 200 or may receive the signal or power from the outside. In an embodiment, the antenna module 275 may be disposed in the first temple 204 and/or the second temple 205. For example, the antenna module 275 may be disposed close to one surface of the first temple 204 and/or the second temple 205.

The speaker 292-1 and 292-2 may output a sound signal to the outside of the electronic device 200. A sound output module may be referred to as a speaker. In an embodiment, the speaker 292-1 and 292-2 may be disposed in the first temple 204 and/or the second temple 205 in order to be disposed adjacent to the car of the user wearing the electronic device 200. For example, the speaker 292-1 and 292-2 may include a second speaker 292-2 disposed adjacent to the user's left ear by being disposed in the first temple 204, and a first speaker 292-1 disposed adjacent to the user's right car by being disposed in the second temple 205.

The light emitting module (not illustrated) may include at least one light emitting element. The light emitting module may emit light of a color corresponding to a specific state or may emit light through an operation corresponding to the specific state in order to visually provide information on a specific state of the electronic device 200 to the user. For example, when the electronic device 200 requires charging, it may emit red light at a constant cycle. In an embodiment, the light emitting module may be disposed on the first rim 201 and/or the second rim 202.

Referring to FIG. 2B, according to an embodiment, the electronic device 200 may include the printed circuit board (PCB) 290. The PCB 290 may be included in at least one of the first temple 204 or the second temple 205. The PCB 290 may include an interposer disposed between at least two sub PCBs. On the PCB 290, one or more hardware (e.g., hardware illustrated by different blocks of FIG. 4) included in the electronic device 200 may be disposed. The electronic device 200 may include a flexible PCB (FPCB) for interconnecting the hardware.

According to an embodiment, the electronic device 200 may include at least one of a gyro sensor, a gravity sensor, and/or an acceleration sensor for detecting the posture of the electronic device 200 and/or the posture of a body part (e.g., a head) of the user wearing the electronic device 200. Each of the gravity sensor and the acceleration sensor may measure gravity acceleration, and/or acceleration based on preset 3-dimensional axes (e.g., x-axis, y-axis, and z-axis) perpendicular to each other. The gyro sensor may measure angular velocity of each of preset 3-dimensional axes (e.g., x-axis, y-axis, and z-axis). At least one of the gravity sensor, the acceleration sensor, and the gyro sensor may be referred to as an inertial measurement unit (IMU). According to an embodiment, the electronic device 200 may identify the user's motion and/or gesture performed to execute or stop a specific function of the electronic device 200 based on the IMU.

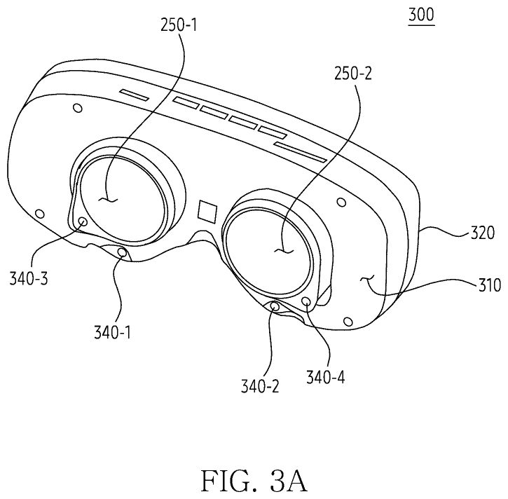

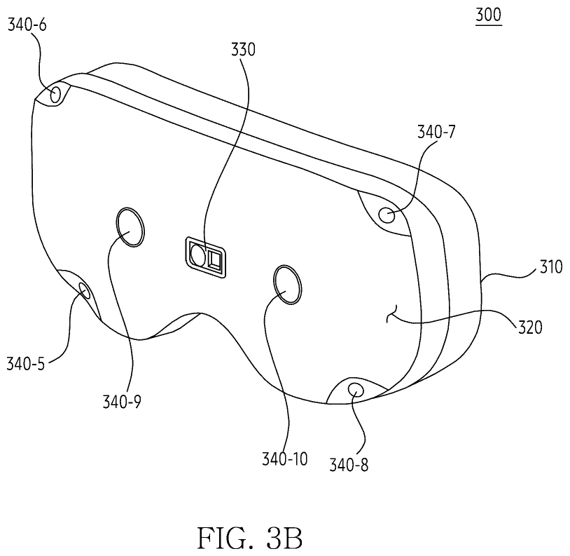

FIGS. 3A and 3B are perspective views illustrating an example of an external appearance of an electronic device according to various embodiments. An electronic device 300 of FIGS. 3A and 3B may be an example of the electronic device 101 of FIG. 1. According to an embodiment, an example of an external appearance of a first surface 310 of a housing of the electronic device 300 may be illustrated in FIG. 3A, and an example of an external appearance of a second surface 320 opposite to the first surface 310 may be illustrated in FIG. 3B.

Referring to FIG. 3A, according to an embodiment, the first surface 310 of the electronic device 300 may have an attachable shape on the user's body part (e.g., the user's face). Although not illustrated, the electronic device 300 may further include a strap for being fixed on the user's body part, and/or one or more temples (e.g., the first temple 204 and/or the second temple 205 of FIGS. 2A to 2B). A first display 250-1 for outputting an image to the left eye among the user's two eyes and a second display 250-2 for outputting an image to the right eye among the user's two eyes may be disposed on the first surface 310. The electronic device 300 may further include rubber or silicon packing, which are formed on the first surface 310, for preventing and/or reducing interference by light (e.g., ambient light) different from the light emitted from the first display 250-1 and the second display 250-2.

According to an embodiment, the electronic device 300 may include cameras 340-1 and 340-2 for photographing and/or tracking two eyes of the user adjacent to each of the first display 250-1 and the second display 250-2. The cameras 340-1 and 340-2 may be referred to as an ET camera. According to an embodiment, the electronic device 300 may include cameras 340-3 and 340-4 for photographing and/or recognizing the user's face. The cameras 340-3 and 340-4 may be referred to as a FT camera.

Referring to FIG. 3B, a camera (e.g., cameras 340-5, 340-6, 340-7, 340-8, 340-9, and 340-10), and/or a sensor (e.g., the depth sensor 330) for obtaining information associated with the external environment of the electronic device 300 may be disposed on the second surface 320 opposite to the first surface 310 of FIG. 3A. For example, the cameras 340-5, 340-6, 340-7, 340-8, 340-9, and 340-10 may be disposed on the second surface 320 in order to recognize an external object. For example, using cameras 340-9 and 340-10, the electronic device 300 may obtain an image and/or video to be transmitted to each of the user's two eyes. The camera 340-9 may be disposed on the second surface 320 of the electronic device 300 to obtain an image to be displayed through the second display 250-2 corresponding to the right eye among the two eyes. The camera 340-10 may be disposed on the second surface 320 of the electronic device 300 to obtain an image to be displayed through the first display 250-1 corresponding to the left eye among the two eyes.

According to an embodiment, the electronic device 300 may include the depth sensor 330 disposed on the second surface 320 in order to identify a distance between the electronic device 300 and the external object. Using the depth sensor 330, the electronic device 300 may obtain spatial information (e.g., a depth map) about at least a portion of the FoV of the user wearing the electronic device 300.

Although not illustrated, a microphone for obtaining sound outputted from the external object may be disposed on the second surface 320 of the electronic device 300. The number of microphones may be one or more according to various embodiments.

As described above, the electronic device 101 according to an embodiment may include hardware (e.g., the cameras 340-5, 340-6, 340-7, 340-8, 340-9, 340-10, and/or the depth sensor 330) for identifying the external display (e.g., the external display 150 of FIG. 1). The electronic device 101 may display at least one screen (e.g., the screen 130 of FIG. 1) in a three-dimensional image (e.g., an image corresponding to the virtual space) based on a size of the identified external display and/or a relative positional relationship of the external display.

FIG. 4 is a block diagram illustrating an example configuration of an electronic device according to various embodiments. An electronic device 101 of FIG. 4 may be an example of the electronic device 101 of FIG. 1 and the electronic device 101 of FIGS. 2A to 3B.

Referring to FIG. 4, the electronic device 101 according to an embodiment may include at least one processor (e.g., including processing circuitry) 420, memory 430, a camera 440, a display 450, a sensor 460, and/or communication circuitry 470. The processor 420, the memory 430, the camera 440, the display 450, the sensor 460, and the communication circuitry 470 may be electrically and/or operably coupled with each other by an electronical component (or an electrical element) such as a communication bus. A type and/or the number of hardware components included in the electronic device 101 are not limited as illustrated in FIG. 4. For example, the electronic device 101 may include only some of the hardware components illustrated in FIG. 4.

The processor 420 of the electronic device 101 according to an embodiment may include a hardware component for processing data based on one or more instructions. The hardware component for processing the data may include, for example, an arithmetic and logic unit (ALU), a field programmable gate array (FPGA), and/or a central processing unit (CPU). The number of processors 420 may be one or more. For example, the processor 420 may have a structure of a multi-core processor such as a dual core, a quad core, or a hexa core. Thus, the processor 420 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 430 of the electronic device 101 according to an embodiment may include a hardware component for storing data and/or instructions inputted to and/or outputted from the processor 420. The memory 430 may include, for example, volatile memory such as random-access memory (RAM) and/or non-volatile memory such as read-only memory (ROM). The volatile memory may include, for example, at least one of dynamic RAM (DRAM), static RAM (SRAM), Cache RAM, and pseudo SRAM (PSRAM). The non-volatile memory may include at least one of, for example, programmable ROM (PROM), erasable PROM (EPROM), electrically erasable PROM (EEPROM), flash memory, a hard disk, a compact disk, and an embedded multi media card (eMMC).

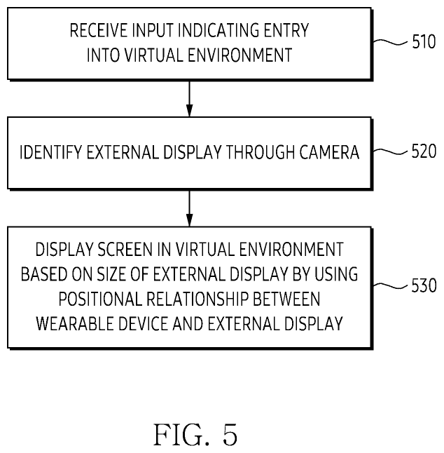

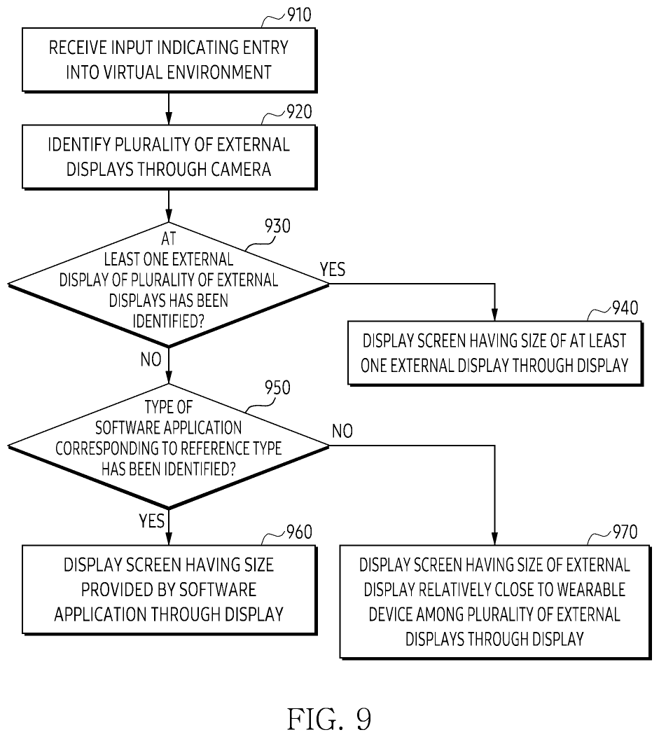

In the memory 430 of the electronic device 101 according to an embodiment, one or more instructions (or commands) indicating a calculation and/or an operation to be performed on data by the processor 420 of the electronic device 101 may be stored. A set of one or more instructions may be referred to as a firmware, an operating system, a process, a routine, a sub-routine, and/or an application. For example, the electronic device 101 and/or the processor 420 may perform at least one of operations of FIGS. 5, 9, and/or 15 when a set of a plurality of instructions distributed in a form of the operating system, the firmware, a driver, and/or the application is executed. Hereinafter, the application being installed in the electronic device 101 may refer, for example, to the one or more instructions provided in a form of the application being stored in the memory 430, and that the one or more applications are stored in a format (e.g., a file with an extension preset by the operating system of the electronic device 101) executable by the processor 420. As an example, the application may include a program, a software application, and/or a library associated with a service (e.g., a virtual reality service) provided to a user.

For example, the electronic device 101 may distinguish software applications installed in the memory 430 according to a type of the software application. The electronic device 101 may distinguish a utility software application 432 including software applications that provide business, a book, and an augmented reality service, and a multimedia software application 435 including software applications that provide the augmented reality service such as a game and entertainment, based on the type. The electronic device 101 may change a size of a screen displayed within a three-dimensional image based on the type of the software application for displaying the three-dimensional image.

The camera 440 of the electronic device 101 according to an embodiment may include one or more optical sensors (e.g., a charged coupled device (CCD) sensor and a complementary metal oxide semiconductor (CMOS) sensor) that generate an electrical signal indicating a color and/or brightness of light. A plurality of optical sensors in the camera 440 may be arranged in a form of a 2 dimensional array. The camera 440 may generate an image including a plurality of pixels arranged in two dimensions and corresponding to light reaching the optical sensors of the 2 dimensional array by obtaining the electrical signal of each of the plurality of optical sensors substantially simultaneously. For example, photo data captured using the camera 440 may refer, for example, to an image obtained from the camera 440. For example, video data captured using the camera 440 may refer, for example, to a sequence of a plurality of images obtained from the camera 440 according to a preset frame rate.

The display 450 of the electronic device 101 according to an embodiment may be controlled by a controller such as the processor 420 to output visualized information to the user. The display 450 may include a flexible display, a flat panel display (FPD), a liquid crystal display (LCD), a plasma display panel (PDP), and/or a plurality of light emitting diodes (LEDs). The LED may include an organic LED (OLED). The display 450 may have at least a partially curved shape or may have a deformable shape. For example, the display 450 may be used to display an image obtained by the processor 420 or an image obtained by display driving circuitry. For example, the electronic device 101 may display an image on a portion of the display 450 according to a control of the display driving circuitry. However, the disclosure is not limited thereto.

For example, the electronic device 101 may identify a visual object corresponding to an external object (e.g., the external display 150 of FIG. 1) using the image while displaying the image (e.g., the frame image 125 of FIG. 1) obtained through a camera on the display 450. The electronic device 101 may identify a positional relationship between the external object and the electronic device based on the camera or a sensor.

The sensor 460 of the electronic device 101 according to an embodiment may generate electronic information that may be processed by the processor 420 and/or the memory 430 of the electronic device 101 from non-electronic information associated with the electronic device 101. For example, the sensor 460 may include an inertia measurement unit (IMU) for detecting a physical motion of the electronic device 101. The IMU may include an acceleration sensor, a gyro sensor, a geomagnetic sensor, or a combination thereof. The acceleration sensor may output data indicating a direction and/or magnitude of a gravitational acceleration applied to the acceleration sensor along a plurality of axes (e.g., x-axis, y-axis, and z-axis) perpendicular to each other. The gyro sensor may output data indicating rotation of each of the plurality of axes. The geomagnetic sensor may output data indicating a direction (e.g., a direction of an N pole or an S pole) of a magnetic field in which the geomagnetic sensor is included. The IMU in the sensor 460 may be referred to as a motion sensor in terms of detecting a motion of the electronic device 101. For example, the electronic device 101 may identify a direction of the electronic device 101 by controlling the sensor 460. The direction of the electronic device 101 may be referred to a gaze direction of the user (e.g., the user 105 of FIG. 1) wearing the electronic device 101. Based on identifying the direction, the electronic device 101 may display a screen (e.g., the frame image 115 of FIG. 1) indicated in a real space based on the direction in the display. The electronic device may display a screen (e.g., the three-dimensional image 125 of FIG. 1) indicating a virtual space on the display in a virtual environment (e.g., the environment 120 of FIG. 1).

1 For example, the sensor 460 may include a proximity sensor and/or a grip sensor for identifying an external object in contact on a housing of the electronic device 101. The number and/or a type of the sensor 460 is not limited to those described above, and a sensor 230 may include an image sensor, an illumination sensor, a time-of-flight (ToF) sensor, and/or a global positioning system (GPS) sensor for detecting an electromagnetic wave including light.

The communication circuitry 470 of the electronic device 101 according to an embodiment may include hardware for supporting transmission and/or reception of data between the electronic device 101 and an external electronic device (e.g., a server, and/or a terminal different from the electronic device 101). For example, the communication circuitry 470 may include at least one of a modem (MODEM), an antenna, and an optic/electronic (O/E) converter. The communication circuitry 470 may support transmission and/or reception of an electrical signal based on various types of protocols such as an ethernet, a local area network (LAN), a wide area network (WAN), a wireless fidelity (WiFi), Bluetooth, a bluetooth low energy (BLE), ZigBee, a long term evolution (LTE), Thread, Matter, and a 5G new radio (NR). The electronic device 101 may provide the service (e.g., the virtual reality service) of the software application to a user using the communication circuitry 470.

Hereinafter, in FIG. 5, an example operation in which the electronic device 101 uses an external display 150 included in a reality environment to maintain a unity between the reality environment (e.g., the environment 110 of FIG. 1) and the virtual environment (e.g., the environment 120 of FIG. 1) will be described in greater detail.

FIG. 5 is a flowchart illustrating an example operation of an electronic device according to various embodiments. At least one of operations of FIG. 5 may be performed by the electronic device 101 of FIG. 4 and/or the processor 420 of FIG. 4. Each of the operations of FIG. 5 may be performed sequentially, but is not necessarily performed sequentially. For example, an order of each of the operations may be changed, and at least two operations may be performed in parallel. Further, when operations are described as being performed by the processor, this includes where the electronic device is caused to perform the operation(s) by the processor and/or performs the operation(s) under control of the processor.

Referring to FIG. 5, in operation 510, a processor according to an embodiment may receive an input indicating an entry into a virtual environment. For example, the processor may receive the input while displaying a frame image (e.g., the frame image 115 of FIG. 1) corresponding to a reality environment (e.g., the environment 110 of FIG. 1) on a display (e.g., the display 450 of FIG. 4) through a camera. The processor may receive the input while identifying an external display using the frame image. The processor may temporarily cease displaying the frame image and receive the input indicating execution of a software application for initiating a display of a three-dimensional image. Based on receiving the input, the processor may display a three-dimensional image not including the external display on the display by replacing the frame image including the external display. However, the disclosure is not limited thereto. The processor may initiate the identification of the external display through the frame image in response to receiving the input for the display of the three-dimensional image while displaying the frame image corresponding to the reality environment through the camera. The processor may receive the input for executing the software application while displaying the frame image obtained through the camera. In response to receiving the input, the processor may initiate the execution of the software application to display the three-dimensional image on the display. However, the disclosure is not limited thereto.

Referring to FIG. 5, in operation 520, the processor according to an embodiment may identify the external display through the camera. An operation of identifying the external display through the camera by the processor may include an operation of identifying a visual object corresponding to the external display included in the frame image (e.g., the frame image 115 of FIG. 1) obtained through the camera. The operation of identifying the external display by the processor may include an operation of obtaining a positional relationship based on identifying a direction from the electronic device toward the external display and a distance between the electronic device and the external display using the camera. In order to obtain the positional relationship, the processor may identify a depth distance for the visual object (e.g., the visual object corresponding to the external display) within the frame image. The depth distance may be obtained by a sensor (e.g., a depth sensor). The processor may identify the distance (e.g., the distance 117 of FIG. 1) between the electronic device and the external display using data indicating the depth distance obtained by the sensor. Based on identifying the external display included in the frame image obtained through the camera, the processor may identify a size of a screen to be displayed after displaying the three-dimensional image using the external display.

Referring to FIG. 5, in operation 530, the processor according to an embodiment may display the screen in the virtual environment based on a size of the external display using a positional relationship between the electronic device and the external display. The processor may display a three-dimensional image (e.g., the three-dimensional image 125 of FIG. 1) indicating the virtual environment on the display using a software application for displaying the screen. As an example, in a case that the screen is displayed in the virtual environment based on a distance greater than or equal to a preset distance, the electronic device may display the screen based on a bent shape (e.g., a curved surface). As an example, the screen based on the bent shape may be displayed in response to an input indicating that a video provided from a software application (e.g., a multimedia software application) is played. The electronic device may display the screen based on the bent shape on the display so that a user may immerse himself in the virtual environment. However, the disclosure is not limited thereto. The screen may be provided by the software application providing an augmented reality service. The size of the screen may be obtained based on the size of the external display identified through the camera. A shape of the screen may be identified based on a shape of the external display.

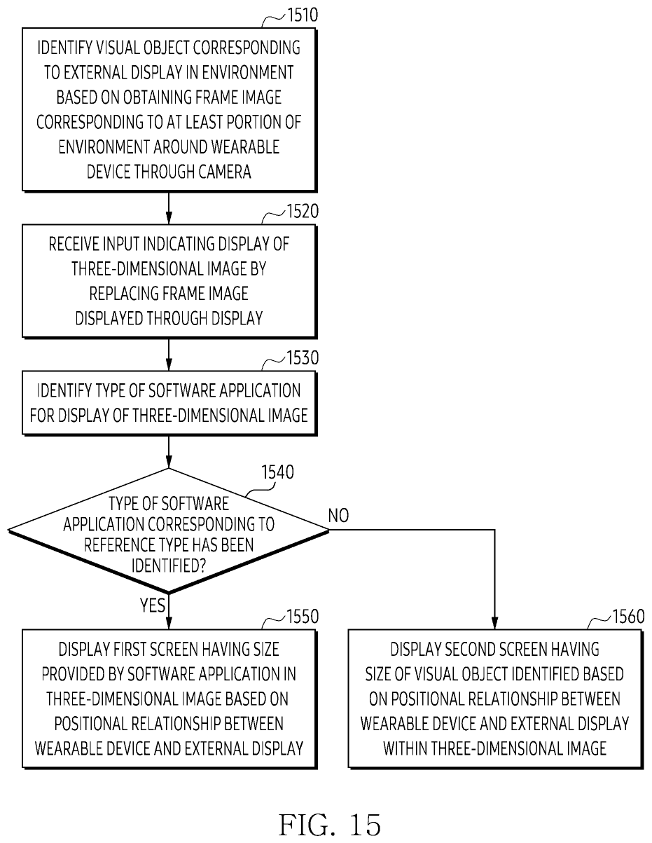

For example, the processor may identify a type of a software application corresponding to the screen to display the screen. An electronic device 101 may change the size of the screen according to whether the type of the software application corresponding to the screen corresponds to a reference type. In a case of the multimedia software application corresponding to the screen, the processor may display the screen on the display based on a relatively largest size among sizes that may be displayed in the three-dimensional image (e.g., the three-dimensional image 125 of FIG. 1). In a case that the type of the software application is a different type (e.g., a utility software application) distinct from the reference type, the screen may be displayed on the display based on the size of the external display obtained through the camera. An operation of the electronic device 101 identifying the type of the software application will be described later with reference to FIG. 15.

In response to receiving the input indicating the entry into the virtual environment, the processor may maintain a unity between a service providing the reality environment and a service providing the virtual environment by displaying the screen based on the positional relationship (e.g., the positional relationship between the electronic device and the external display) obtained through the camera.

Hereinafter, an example of an operation for displaying at least a portion of a virtual space based on receiving the input indicating that the electronic device 101 has entered the virtual space will be described in greater detail below.

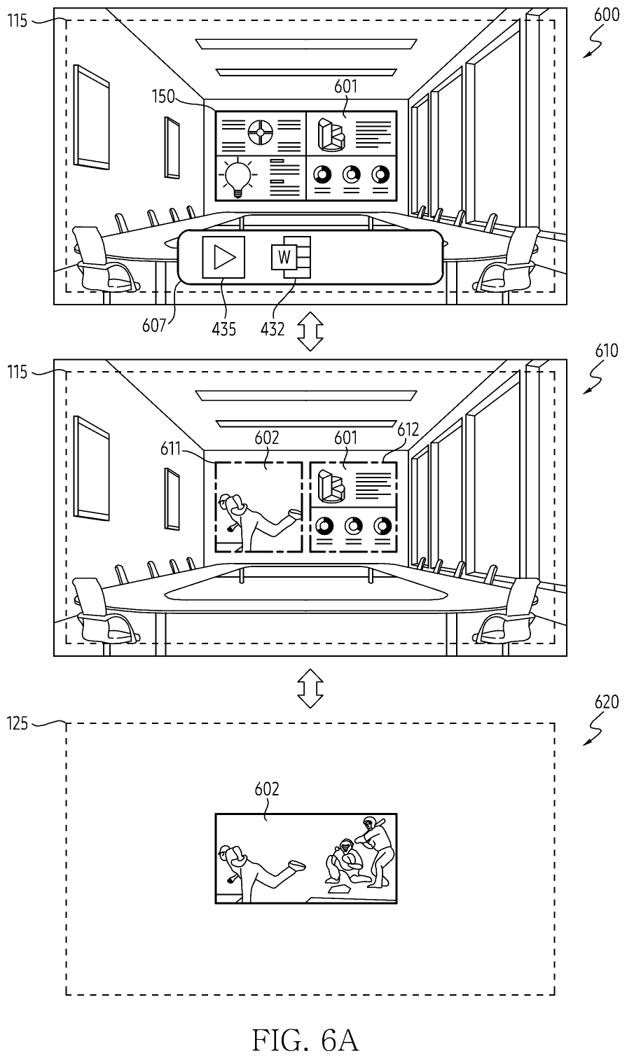

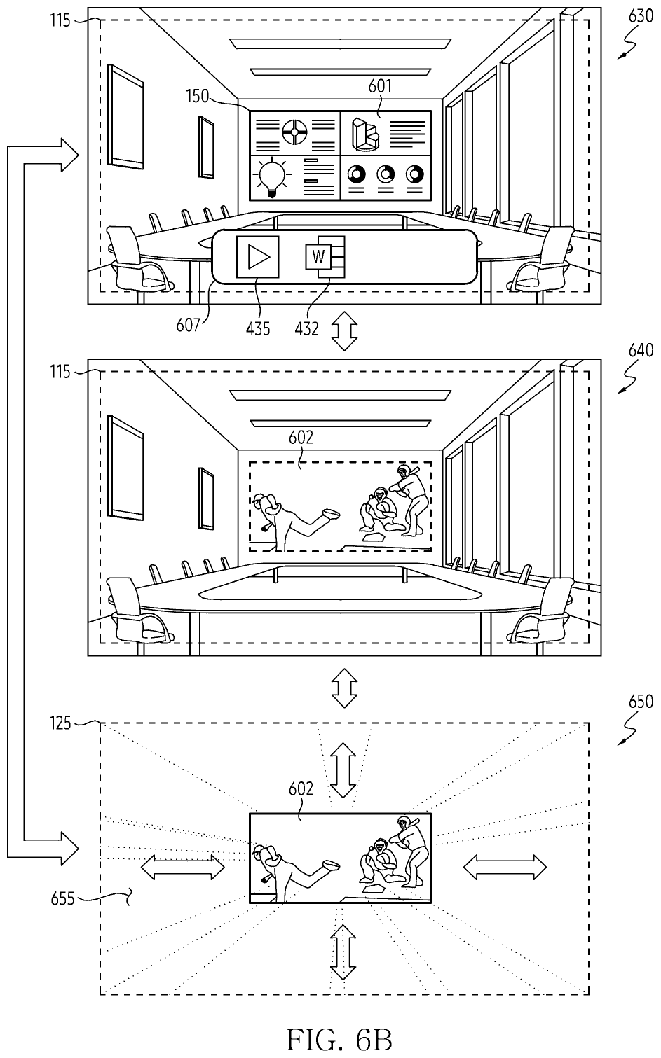

FIGS. 6A and 6B are diagrams illustrating an example operation of an electronic device to display at least a portion of a virtual space according to various embodiments. An electronic device 101 of FIGS. 6A to 6B may include the electronic device 101 of FIGS. 1 to 5.

Referring to FIG. 6A, the electronic device 101 according to an embodiment may identify an external display 150 in an environment 600 displaying a frame image 115 corresponding to a reality space. While displaying the frame image 115 on a display, the electronic device 101 may display a visual object 607 including a list of software applications stored in memory (e.g., the memory 430 of FIG. 4).

For example, the electronic device 101 may obtain a size, a shape, and/or a positional relationship of the external display 150 based on identifying the external display 150. As an example, the shape may include a shape in which the external display 150 is inclined. A screen 601 may be an example of a screen displayed through the external display 150.

For example, the electronic device 101 may receive an input indicating a display of a three-dimensional image 125 while displaying the frame image 115 on the display. The electronic device 101 may initiate the display of the three-dimensional image 125 based on receiving an input indicating selection of at least one of the software applications included in the visual object 607. For example, the electronic device 101 may identify a type of a software application executed to initiate the display of the three-dimensional image 125. A size of a screen 602 provided in the three-dimensional image 125 may vary according to the type of the software application.

For example, in a case that the type of the executed software application corresponds to a reference type (e.g., a multimedia software application), the size of the screen 602 may have a size provided by the executed software application. In a case that the type of the executed software application is different from the reference type (e.g., the multimedia software application), the size of the screen 602 may correspond to the size of the external display 150. However, the disclosure is not limited thereto.

For example, the electronic device 101 may identify the positional relationship with respect to the external display 150 to initiate the display of the three-dimensional image 125. The positional relationship may include distance information between the electronic device 101 and the external display 150.

For example, in an environment 610, the electronic device 101 may display the screen 602 provided by the executed software application based on the positional relationship. The environment 610 may include a state in which the electronic device 101 initiates execution of a software application for the display of the three-dimensional image 125.

For example, the electronic device 101 may display at least a portion of the screen 602 by overlapping a visual object corresponding to the external display 150 displayed on the display. The electronic device 101 may expand a region in which the screen 602 is to be displayed from a region 611 corresponding to the visual object to another region 612.

For example, the electronic device 101 may display the screen 602 in an environment 620 that displays at least a portion of the virtual space. The electronic device 101 may display the screen 602 having the size of the external display 150 on the display in the three-dimensional image 125 corresponding to at least a portion of the virtual space. The electronic device 101 may display the screen 602 based on the positional relationship corresponding to an external display. The three-dimensional image 125 may be obtained by the executed software application. The three-dimensional image 125 may be obtained based on the reality space corresponding to the frame image 125 obtained through a camera. As an example, the three-dimensional image 125 in the environment 620 may include at least a portion of the virtual space corresponding to the reality space (e.g., an office space) corresponding to the environment 600. However, the disclosure is not limited thereto. The electronic device 101 may reduce a sense of difference that may occur to a user by an operation of switching from a reality environment to a virtual environment by gradually expanding the region in which the screen 602 is to be displayed based on the size of the external display 150.

Referring to FIG. 6B, in an environment 630, the electronic device 101 according to an embodiment may display the frame image 115 obtained through the camera on the display. The environment 630 may be referred to the environment 600 of FIG. 6A.

In the environment 630 according to an embodiment, the electronic device 101 may initiate execution of a software application (e.g., a multimedia software application 435 or a utility software application 432) based on receiving an input for displaying the three-dimensional image 125. The environment 630 may include the electronic device 101 initiating the execution of the software application. For example, the electronic device 101 may display the screen 602 based on the positional relationship between the electronic device 101 and the external display 150 using the size of the external display 150. The screen 602 may be provided by the software application in which the execution has been initiated. The screen 602 may be displayed by overlapping at least a portion (e.g., a portion where the visual object corresponding to the external display 150 is displayed) of the frame image 115. However, the disclosure is not limited thereto.

For example, the electronic device 101 may obtain the three-dimensional image 125 based on expanding the screen 602 in an environment 655. The electronic device 101 may display the extended screen 602 in the other region 612 distinct from the region 611 in which the screen 602 is displayed in the three-dimensional image 125. An operation of the electronic device 101 to expand the screen 602 may include an operation of matching each of edges of the screen 602 with each of edges of the three-dimensional image 125 adjacent thereto. In order to provide an effect indicating an entry into a virtual reality, the electronic device 101 may expand the screen 602 having the size of the external display 150 to correspond to a size of the three-dimensional image 125. However, the disclosure is not limited thereto.

For example, the electronic device 101 may change the size of the screen 602 from a size corresponding to the three-dimensional image 125 to the size of the external display 150 based on initiating the execution of a software application that provides the display of the three-dimensional image 125. The electronic device 101 may provide a sense of immersion in the virtual reality by changing the size of the screen 602 from the size corresponding to the three-dimensional image 125 to the size of the external display 150. However, the disclosure is not limited thereto.

The electronic device 101 according to an embodiment as described above may gradually expand the size of the screen 602 based on the size of the external display 150 in order to maintain continuity with an operation of switching from the real space to the virtual space. For example, the electronic device 101 may change to a screen having the size corresponding to the three-dimensional image 125 by expanding the screen 602 with the size of the external display 150 to provide the sense of immersion in the virtual space.

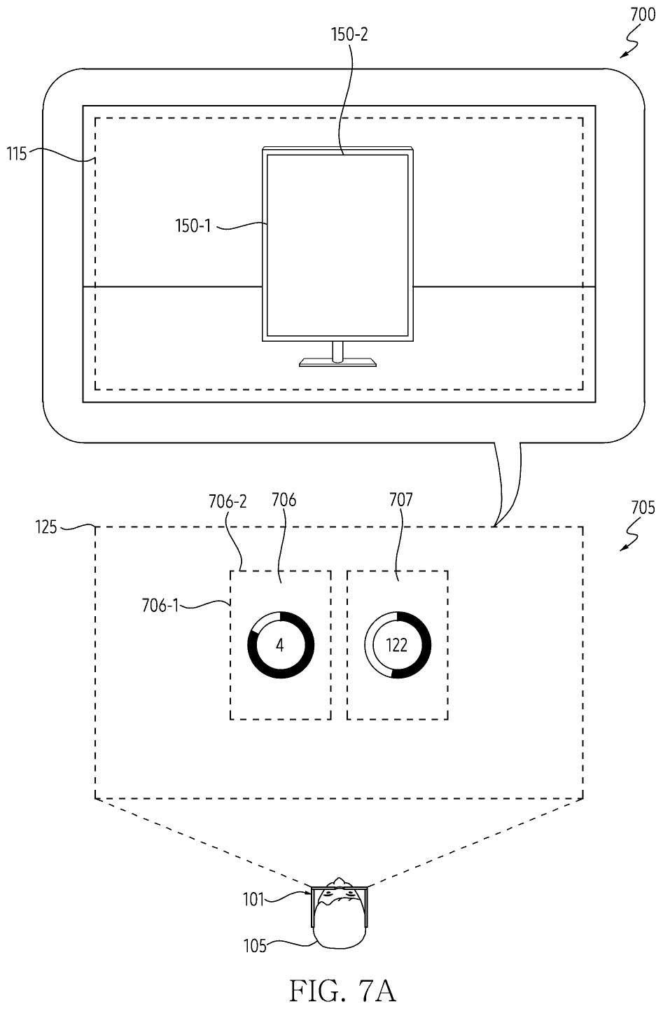

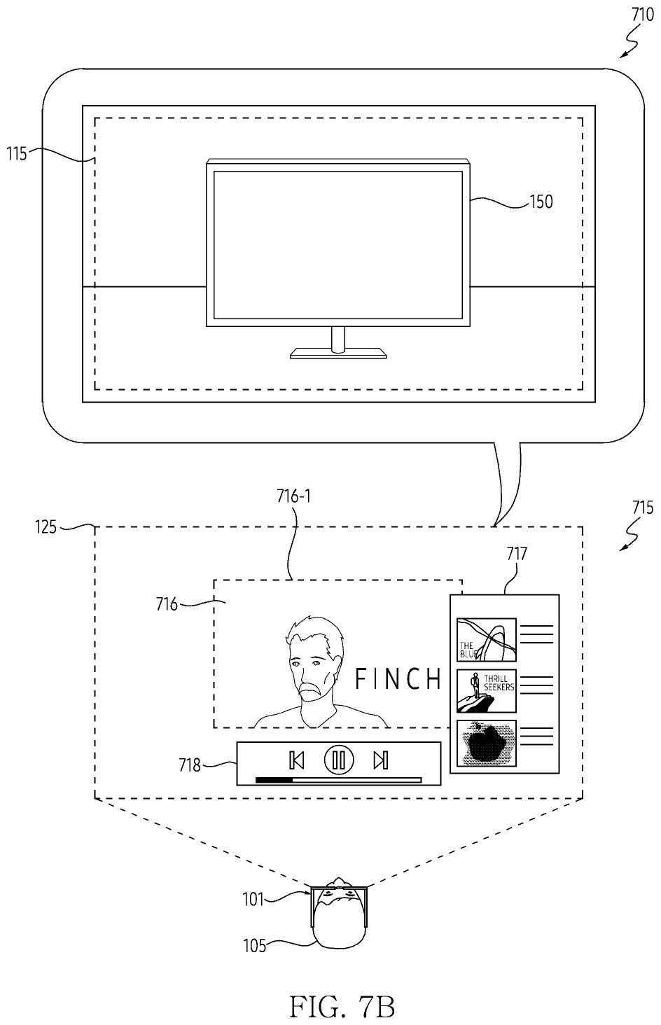

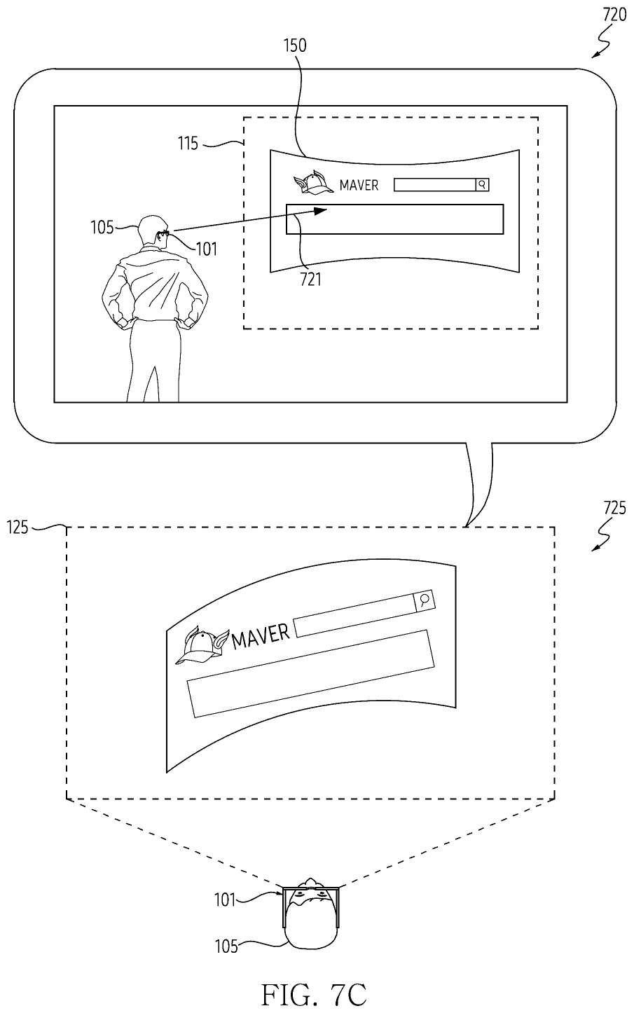

FIGS. 7A, 7B and 7C are diagrams illustrating an example operation in which an electronic device displays a screen based on a size of an external display according to various embodiments. An electronic device 101 of FIGS. 7A to 7C may include the electronic device 101 of FIGS. 1 to 6B.

Referring to FIG. 7A, an example environment 705 in which the electronic device 101 according to an embodiment displays a screen 706 based on a size and/or a positional relationship of an external display 150 is illustrated. The environment 705 may be referred to as a virtual environment in terms of the electronic device 101 providing a virtual environment service using a software application.

For example, the electronic device 101 may display the screen 706 in a three-dimensional image 125 based on a shape of the external display. Before entering the environment 705, the electronic device 101 may identify a shape of the screen 706 using the shape of the external display 150 obtained through a camera in an environment 700. The environment 700 may be referred to as a real environment in terms of displaying at least a portion of a real space in which the electronic device 101 is positioned through the camera.

For example, the electronic device 101 may identify the external display 150 in which a second edge 150-2 has a shape shorter than a first edge 150-1 in the environment 700. In terms of the first edge 150-1 corresponding to a height of the external display 150 being longer than the second edge 150-2 corresponding to a width of the external display 150, the external display 150 may be referred to as a vertical external display.

For example, the electronic device 101 may identify the shape of the screen 706 using the first edge 150-1 and the second edge 150-2 of the external display 150. For example, the shape of the screen 706 may be identified such that a first edge 706-1 of the screen 706 corresponds to the first edge 150-1 of the external display 150 and a second edge 706-2 of the screen 706 corresponds to the second edge 150-2 of the external display 150. The first edge 706-1 of the screen 706 may correspond to a height of the screen 706. The second edge 706-2 of the screen 706 may correspond to a width of the screen 706. In terms of the first edge 706-1 being longer than the second edge 706-2, the screen 706 may be referred to as a vertical UI.

For example, the electronic device 101 may display the screen 706 in the three-dimensional image 125 based on the shape, the size, and/or the positional relationship of the external display 150. The electronic device 101 may use the shape, the size, and/or the positional relationship of the external display 150 to display another screen 706 distinct from the screen 706. The other screen 706 may be obtained based on identifying interaction between a user 105 and the screen 706. The other screen 706 may be associated with a function of the electronic device 101 corresponding to the screen 706. The electronic device 101 may display another screen 707 on the display by receiving an input for displaying the other screen 707 in the three-dimensional image 125 using the screen 706.

For example, the electronic device 101 may identify a size, a shape, and/or a position of the screen 707 to be displayed in the three-dimensional image 125 to correspond to the screen 706. The size of the screen 707 may correspond to the size of the screen 706. The shape of the screen 707 may correspond to the shape of the screen 706. A portion in which the screen 707 is displayed in the three-dimensional image 125 may be distinct from a portion in which the screen 706 is displayed. However, the disclosure is not limited thereto. For example, the electronic device 101 may display the screen 707 on the display by overlapping at least a portion of the screen 706. For example, the electronic device 101 may display the screen 707 based on a size, a shape, and/or a position provided by the software application for displaying the three-dimensional image 125.

In an embodiment, the electronic device 101 may identify the shape of the screen 706 provided by a software application distinct from the shape of the external display 150. For example, the shape of the screen 706 provided by the software application may be identified based on a shape in which the second edge 706-2 is longer than the first edge 706-1. In terms of the second edge 706-2 being longer than the first edge 706-1, the screen 706 may be referred to as a horizontal UI. For example, in order to display the horizontal-based screen 706 on the display, the electronic device 101 may identify the longest edge (e.g., the first edge 150-1) among edges of the external display 150. The electronic device 101 may obtain the shape of the screen 706 so that the second edge 706-2 of the horizontal-based screen 706 corresponds to the longest edge (e.g., the first edge 150-1) and the first edge 706-1 of the horizontal-based screen 706 corresponds to another edge (e.g., the second edge 150-2) of the external display 150. Based on the obtained shape of the screen 706, the electronic device 101 may display the screen 706 having another shape (e.g., horizontal) distinct from the shape (e.g., vertical) of the external display 150 and having the size of the external display 150 on the display.

Referring to FIG. 7B, the electronic device 101 according to an embodiment may display a screen 716 on the display in an environment 715 based on a size, a shape, and/or a positional relationship of the external display 150 included in an environment 710. The environment 710 may be referred to as the real environment in terms of displaying the at least a portion of the real space in which the electronic device 101 is positioned through the camera. The environment 715 may be referred to as the virtual environment in terms of the electronic device 101 providing the virtual environment service using a software application.

For example, the electronic device 101 may display the screen 716 on the display using a multimedia software application (e.g., the multimedia software application 435 of FIG. 4) that provides a video service. The electronic device 101 may display the screen 716 having the size of the external display 150. The electronic device 101 may identify a portion 716-1 of the three-dimensional image 125 based on the size of the external display 150 and a positional relationship between the electronic device 101 and the external display 150. The electronic device 101 may identify a type (e.g., the multimedia software application) of a software application executed to display the three-dimensional image 125. For example, in a case that the executed software application provides the video service, the electronic device 101 may display the screen 716 indicating a video in the portion 716-1. The screen 716 indicating the video may correspond to main content among contents available to provide the video service.

For example, the electronic device 101 may display other contents distinct from the video among the contents available by the software application providing the video service, in another portion distinct from the portion 716-1. The electronic device 101 may display a visual object 718 associated with playback of the video on the display. A portion in which the visual object 718 is displayed may be different from the portion 716-1. However, the disclosure is not limited thereto. The visual object 718 may be displayed overlapping the screen 716 in response to an input indicating selection of the screen 716. For example, the electronic device 101 may display a visual object 717, on the display, indicating a list of playable videos using the software application providing the video service. The electronic device 101 may display the visual object 717 on the display based on a shape, a size, and a position of the visual object 717 provided by the software application. However, the disclosure is not limited thereto. The electronic device 101 may determine the shape and/or the size of the visual object 717 to be displayed together with the screen 716 using the shape and/or the size of the external display 150. The electronic device 101 may improve utilization of the three-dimensional image 125 based on displaying the main content (e.g., the screen 716) among the contents provided by the software application for displaying the three-dimensional image 125 in the portion 716-1 corresponding to the external display 150.

In an embodiment, the electronic device 101 may identify the type of the software application based on receiving an input indicating the display of the three-dimensional image 125. In a case that the type of the software application is the multimedia software application, the electronic device 101 may display the screen having the size provided by the software application on the display, independently of displaying the screen in the three-dimensional image 125, using the external display 150. However, the disclosure is not limited thereto.

Referring to FIG. 7C, the electronic device 101 according to an embodiment may identify a size, a shape, and/or a positional relationship of the external display 150 through the camera in an environment 720. The environment 720 may be referred to as the real environment in terms of displaying the at least a portion of the real space in which the electronic device 101 is positioned through the camera. An environment 735 may be referred to as the virtual environment in terms of the electronic device 101 providing the virtual environment service using a software application.

For example, the positional relationship may include a relative position of the external display 150 with respect to the electronic device 101. The positional relationship may include distance information between the electronic device 101 and the external display 150. The positional relationship may identify a direction 721 of the electronic device 101 with respect to the external display 150. The shape of the external display 150 identified through the camera may vary according to the direction 721 of the electronic device 101 with respect to the external display 150. The electronic device 101 may display a screen 726 within the three-dimensional image 125 based on the shape of the external display 150 identified based on the direction 721 of the electronic device 101. For example, in an environment 725, the electronic device 101 may provide the virtual environment (e.g., the environment 725) similar to the real environment (e.g., the environment 720) to a user by changing a shape of the screen 726 based on the direction 721.

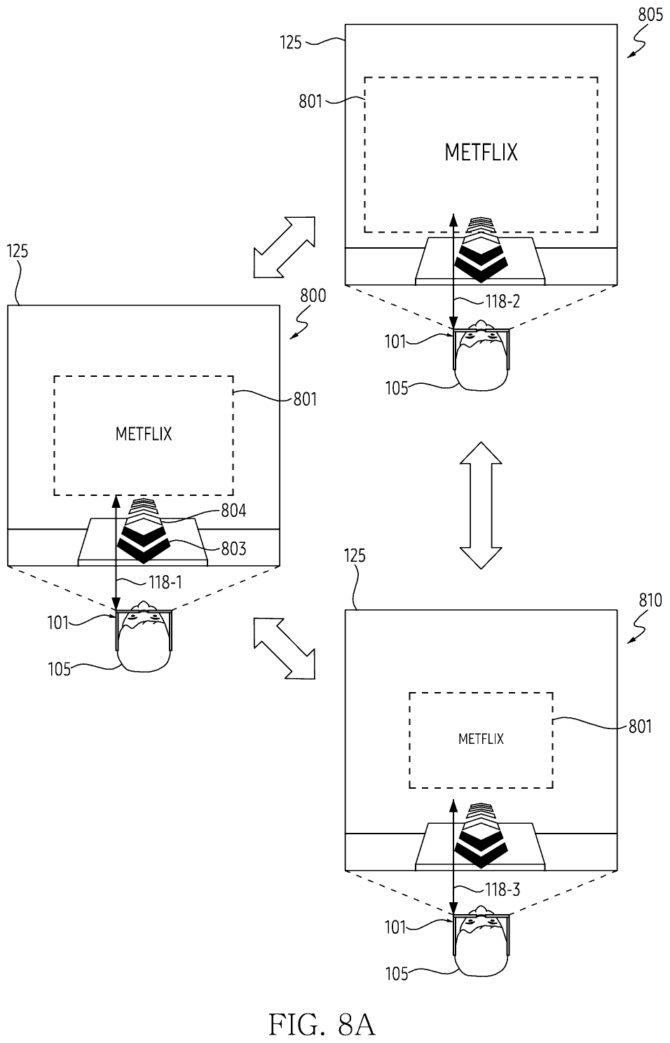

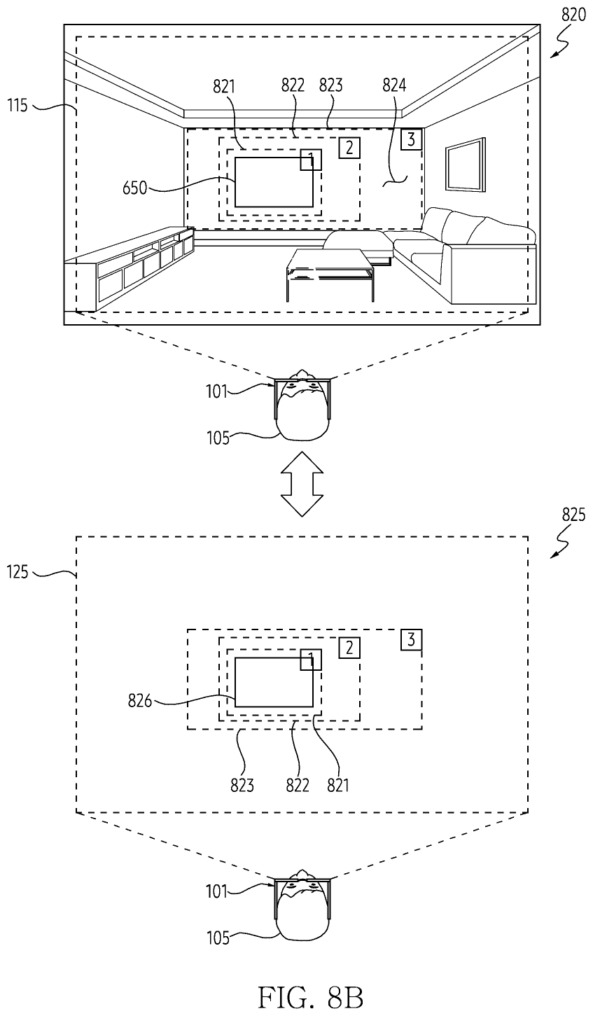

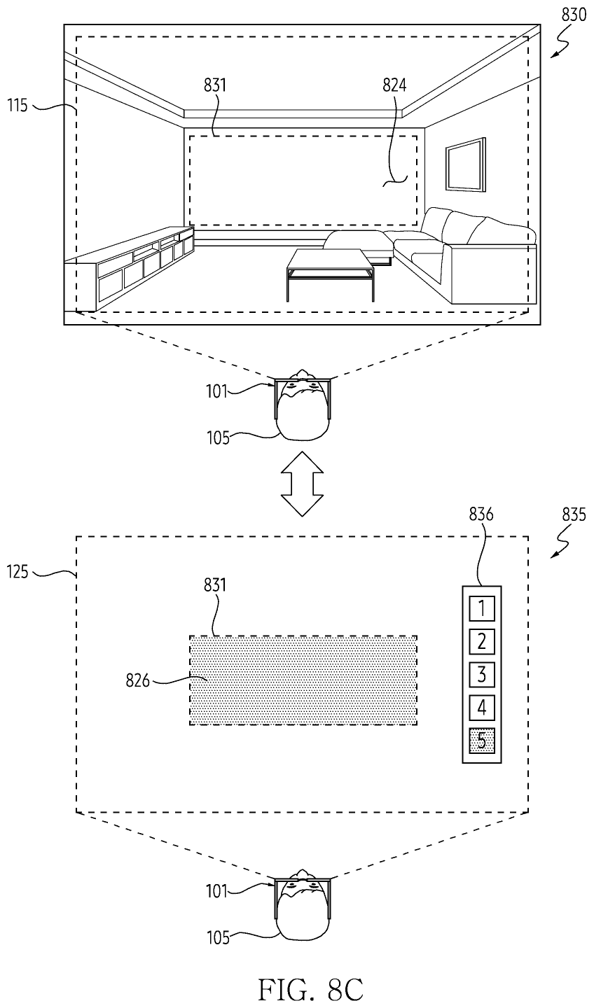

Hereinafter, an example of an operation in which the electronic device 101 changes the size of the screen displayed within the three-dimensional image 125 will be described in greater detail with reference to FIGS. 8A, 8B and 8C.

FIGS. 8A, 8B and 8C are diagrams illustrating an example operation in which an electronic device adjusts a size of a screen displayed on a display according to various embodiments. An electronic device 101 of FIGS. 8A to 8C may include the electronic device 101 of FIGS. 1 to 7C. Environments 800, 805, 810, 825, and 835 of FIGS. 8A, 8B and 8C may be referred to as a virtual environment in terms of displaying a three-dimensional image 125 corresponding to at least a portion of the virtual environment using a software application that provides a virtual environment service by the electronic device 101. An environment 820 of FIG. 8B and an environment 830 of FIG. 8C may be referred to as a real environment in terms of displaying a frame image 115 corresponding to a real space through a camera.

Referring to FIG. 8A, each of the environments 800, 805, and 810 illustrates each of example states in which the electronic device 101 displays the three-dimensional image 125 in response to an input for displaying the three-dimensional image 125. The electronic device 101 according to an embodiment may display a screen 801 corresponding to an external display (e.g., the external display 150 of FIG. 1) within the three-dimensional image 125 in the environment 800. A relative distance 118-1 of the screen 801 of the electronic device 101 may correspond to a distance (e.g., the distance 117 of FIG. 1) between the electronic device 101 and the external display corresponding to the screen 801.

For example, the electronic device 101 may display visual objects 803 and 804 for adjusting a size of the screen 801 on the display. For example, the visual objects 803 and 804 may be used to adjust the distance 118-1.

For example, the electronic device 101 may expand the size of the screen 801 in the environment 805 in response to an input to a visual object 804. Based on expanding the size of the screen 801, a proportion of the screen 801 occupied within the three-dimensional image 125 may increase. The input to the visual object 804 may include an input indicating an operation approaching toward the screen 801. Based on expanding the size of the screen 801, a relative distance 118-2 of the electronic device to the screen 801 may be relatively shorter than the distance 118-1.

For example, the electronic device 101 may reduce the size of the screen 801 in an environment 810 in response to an input to a visual object 803. Based on reducing the size of the screen 801, the proportion of the screen 801 occupied within the three-dimensional image 125 may decrease. The input to the visual object 803 may include an input indicating an operation move away from the screen 801. Based on reducing the size of the screen 801, a relative distance 118-3 of the electronic device to the screen 801 may be relatively longer than the distance 118-1. The electronic device 101 may provide the virtual environment service similar to the real environment in which an external display corresponding to the screen 801 and the electronic device is positioned to a user by adjusting the relative distance 118-1 of the electronic device 101 to the screen 801.

Referring to FIG. 8B, the electronic device 101 according to an embodiment may identify an external display 650 and a plane 824 adjacent to the external display 650 using the frame image 115 obtained through the camera in the environment 820. The electronic device 101 may identify a size 823 of the plane 824 while identifying a size 821, a shape, and/or a positional relationship with respect to the external display 650. The electronic device 101 may identify one or more sizes (e.g., a size 822) according to a preset ratio, from the size 821 of the external display 650 to the size 823 of the plane 824. The external display 650 may be referred to the external display 150 of FIG. 1.

For example, the electronic device 101 in the environment 825 may display a screen 826 having the size 821 of the external display 650 within the three-dimensional image 125 based on identifying the external display 650 and the plane 824. While displaying the screen 826 corresponding to the external display 650, the electronic device 101 may display visual objects for adjusting the size of the screen 826 on the display. Each of the visual objects may correspond to each of one or more sizes 822 and 823 with respect to the plane 824 obtained by the electronic device 101. In response to an input to each of the visual objects, the electronic device 101 may change the size of the screen 826 to a size for each of the visual objects. However, the disclosure is not limited to the example described above.

Referring to FIG. 8C, the environment 830 that does not include an external display (e.g., the external display 150 of FIG. 1) is illustrated. For example, the electronic device 101 may identify that a visual object corresponding to the external display is not included within the frame image 115 based on receiving the input indicating the display of the three-dimensional image 125. In a case that the external display is not identified using the frame image 115, the electronic device 101 may identify the plane 824 similar to the shape of the external display in the frame image 115. The electronic device 101 may identify a size 831, a shape, and/or a positional relationship with respect to the plane 824, independently of identifying the size, the shape, and/or the positional relationship with respect to the external display.

For example, in the environment 835, the electronic device 101 may display the screen 826 within the three-dimensional image 125 based on the size 831, the shape, and/or the positional relationship with respect to the identified plane 824. While displaying the screen 826, the electronic device 101 may display a visual object 836 for changing the size of the screen 826 on the display. The visual object 836 may include icons corresponding to a preset size. In response to an input to each of the icons, the electronic device 101 may change the size 831 of the screen 826 to the preset size corresponding to each of the icons. Referring to FIG. 8C, in a case that the electronic device 101 may not identify the external display, an operation of displaying the visual object 836 for changing the size of the screen 826 in the three-dimensional image 125 has been described, but the disclosure is not limited thereto. As an example, in a case that a screen corresponding to the external display is displayed within the three-dimensional image 125 after identifying the external display through the camera, the electronic device 101 may display a visual object (e.g., the visual object 836) for changing a size of the screen corresponding to the external display within the three-dimensional image 125.

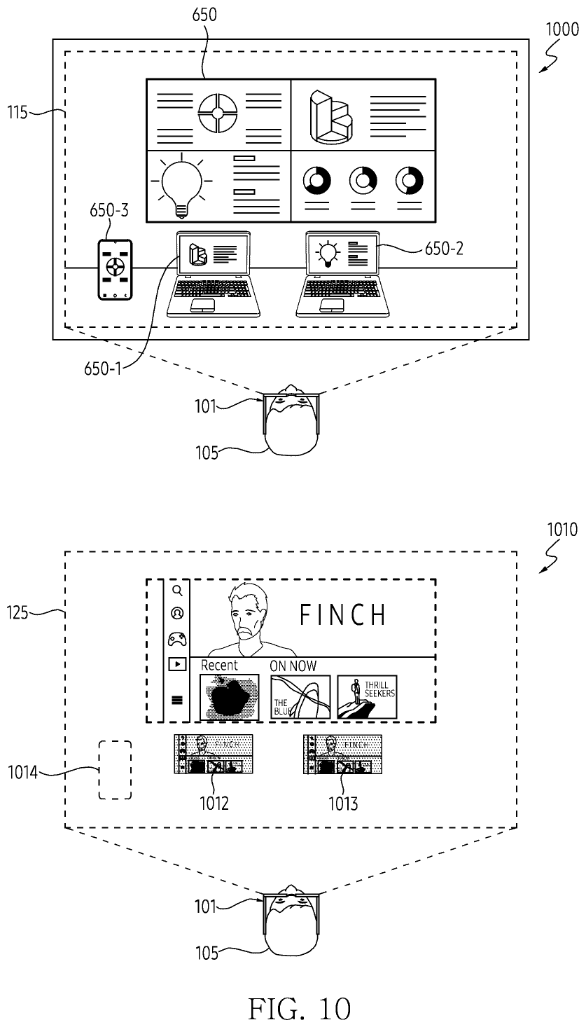

Hereinafter, referring to FIGS. 9 and 10, in a case that the electronic device 101 identifies one or more external electronic devices through the camera, an example of an operation of displaying at least one screen within the three-dimensional image 125 will be described in greater detail.

FIG. 9 is a flowchart illustrating an example operation of an electronic device according to various embodiments. FIG. 10 is a diagram illustrating an example operation in which an electronic device displays a screen corresponding to at least one of a plurality of external displays according to various embodiments. At least one of operations of FIG. 9 may be performed by the electronic device 101 of FIG. 4 and/or the processor 420 of FIG. 4. Each of the operations of FIG. 9 may be performed sequentially, but is not necessarily performed sequentially. For example, an order of each of the operations may be changed, and at least two operations may be performed in parallel. An electronic device 101 of FIG. 10 may be referred to the electronic device 101 of FIGS. 1 to 9. An environment 1000 of FIG. 10 may be referred to as a real environment in terms of displaying a frame image corresponding to a real space on a display through a camera, and an environment 1010 of FIG. 10 may be referred to as a virtual environment in terms of displaying a three-dimensional image 125 on a display.

Referring to FIG. 9, in operation 910, the electronic device according to an embodiment may receive an input indicating an entry into the virtual environment. For example, the electronic device may receive the input while displaying the frame image (e.g., the frame image 115 of FIG. 1) corresponding to the real space on the display using the camera. The input may include an input for initiating execution of a software application that provides an augmented reality service. The input may include an input indicating a display of a three-dimensional image (e.g., the three-dimensional image 125 of FIG. 1) to provide the augmented reality service.

Referring to FIG. 10, the electronic device 101 according to an embodiment may display a frame image 115 obtained through the camera in the environment 1000 on the display. The electronic device 101 may temporarily cease displaying the frame image 115 and identify an input for displaying the three-dimensional image 125. The electronic device 101 may initiate execution of a software application for displaying the three-dimensional image 125 based on identifying the input.

Referring back to FIG. 9, in operation 920, the electronic device according to an embodiment may identify a plurality of external displays through the camera. Referring to FIG. 10, in the environment 1000, the electronic device 101 may identify a plurality of external displays 650, 650-1, 650-2, and 650-3 using visual objects corresponding to the plurality of external displays 650, 650-1, 650-2, and 650-3 in the frame image 115. The plurality of external displays 650, 650-1, 650-2, and 650-3 may be referred to the external display 150 of FIG. 1. The plurality of external displays 650, 650-1, 650-2, and 650-3 may include a television (TV), a personal computer (PC) such as a laptop and a desktop, a smartphone, a smartpad, a tablet PC, a smartwatch, and/or an accessory such as a monitor. In terms of including the accessory, the plurality of external displays 650, 650-1, 650-2, and 650-3 may be referred to as a plurality of external electronic devices.

Referring to FIG. 9, in operation 930, the electronic device according to an embodiment may confirm whether at least one external display of the plurality of external displays has been identified. The electronic device may identify a gaze of a user using an ET camera such as the cameras 340-1 and 340-2 of FIG. 3A. The electronic device may identify at least one external display to which the gaze of the user is matched within the frame image displayed on the display. The electronic device may obtain an input indicating selection of the at least one external display based on identifying the at least one external display to which the gaze of the user is matched. However, the disclosure is not limited thereto. As an example, the electronic device may obtain the input using a user interface (UI) for selecting the at least one external display. As an example, the electronic device may identify at least one external display of the plurality of external displays based on a size and/or a distance of each of the plurality of external displays. In a case of identifying the at least one external display (the operation 930-YES), in operation 940, the electronic device according to an embodiment may display a screen having a size of the matched external display through the display.

Referring to FIG. 10, for example, in the environment 1000, in a case that a gaze of a user 105 matches at least one external display (e.g., an external display 650) of the plurality of external displays 650, 650-1, 650-2, and 650-3, the electronic device 101 may identify a size, a shape, and/or a positional relationship with respect to the external display 650. The electronic device 101 may display a screen 1011 in the environment 1010 based on identifying the size, the shape, and/or the positional relationship with respect to the external display 650. In a case that the gaze of the user 105 matches the at least one external display (e.g., the external display 650) of the plurality of external displays 650, 650-1, 650-2, and 650-3, the electronic device may include a case of identifying the at least one external display based on the distance, the size, and/or a shape of each of the plurality of external displays.

In a case that the at least one external display may not be identified (the operation 930-NO), in operation 950, the electronic device according to an embodiment may confirm whether a type of a software application corresponding to a reference type has been identified. For example, the case where the at least one external display may not be identified may include a case where the external display being matched to the gaze of the user may not be identified. The case where the external display being matched to the gaze of the user may not be identified may include a case where an input indicating no selection of the external display is identified. For example, the type of the software application may be divided into a multimedia software application or a utility software application. The reference type may correspond to the multimedia software application.

In a case that the type of the software application corresponding to the reference type is identified (the operation 950-YES), in operation 960, the electronic device according to an embodiment may display a screen having a size provided by the software application through the display.

Referring to FIG. 10, in a case that the type of the software application for displaying the three-dimensional image 125 corresponds to the reference type in the environment 1010, the electronic device 101 may display the screen 1011 (e.g., a screen based on a maximum size that may be displayed within the three-dimensional image) having the size provided by the software application within the three-dimensional image 125. However, the disclosure is not limited thereto.

For example, in a case that the type of the software application corresponds to the reference type, the electronic device 101 may identify a visual object corresponding to the external display 650 having the largest size among a plurality of visual objects corresponding to the plurality of external displays 650, 650-1, 650-2, and 650-3 included within the frame image 115. For example, before displaying the three-dimensional image 125, the electronic device 101 may identify each of the plurality of visual objects corresponding to each of the plurality of external displays 650, 650-1, 650-2, and 650-3. The electronic device 101 may display the screen 1011 having the size of the largest visual object among sizes of each of the plurality of visual objects within the three-dimensional image 125. An operation of displaying the screen 1011 having the size may include an operation of displaying the screen 1011 generated using the size, the shape, and the positional relationship with respect to the external display 650. As an example, the reference type may include a type for the multimedia software application among a plurality of software applications installed in memory of the electronic device. For example, the type of the software application corresponding to the reference type may be a first type, and the type of the software application distinct from the reference type may be a second type.

For example, while displaying the screen 1011, the electronic device 101 may display visual objects (or screens) for changing the size of the screen 1011 on the display. For example, based on displaying the screen 1011, the electronic device 101 may identify another visual object corresponding to another external electronic device (e.g., the external displays 650-1, 650-2, and 650-3) distinct from the external display 650 among the plurality of visual objects. The electronic device 101 may overlap and display visual objects 1012 and 1013 having different sizes of the other visual object on at least a portion of the screen 1011. For example, the electronic device 101 may display the visual objects 1012 and 1013 in each of other regions distinct from a region in which the screen 1011 is displayed. The size of each of the visual objects 1012 and 1013 may be smaller than the size of the screen 1011. The electronic device 101 may change the size of the screen 1011 using the size of the visual object corresponding to the received input based on receiving the input for each of the visual objects 1012 and 1013. A position, a shape, and/or a size of each of the visual objects 1012 and 1013 may correspond to each of the external displays 650-1 and 650-2. The visual objects 1012 and 1013 may refer, for example, to a preview image for representing the size. However, the disclosure is not limited thereto.

For example, in a case that there is no input for each of the visual objects 1012 and 1013, or in a case of identifying that the gaze of the user 105 on the screen 1011 is matched for a preset time, the electronic device 101 may at least temporarily cease displaying the visual objects 1012 and 1013.

For example, in order to display the visual objects 1012 and 1013 for changing the size of the screen 1011, the electronic device 101 may identify the size of each of the plurality of external displays greater than or equal to a reference size in the frame image 115. The electronic device 101 may obtain a visual object (e.g., the visual objects 1012 or 1013) corresponding to an external display (e.g., the external displays 650-1 or 650-2) having a size greater than or equal to the reference size among the plurality of external displays. The electronic device 101 may temporarily cease obtaining a visual object 1014 corresponding to the external display 650-3 based on identifying the external display 650-3 having a size less than the reference size among the plurality of external displays. However, the disclosure is not limited thereto.

Referring back to FIG. 9, in a case that the type of the software application distinct from the reference type is identified (the operation 950-NO), in operation 970, the electronic device according to an embodiment may display a screen having a size of an external display relatively close to the electronic device among the plurality of external displays through the display. For example, the electronic device may identify an external display capable of receiving a touch input among the plurality of external displays. In order to identify the external display relatively close to the electronic device among the plurality of external displays, the electronic device may identify an external display relatively close to the electronic device among external displays capable of receiving the touch input. The electronic device may identify the external display relatively close to the electronic device so that a user of the electronic device may provide the touch input to the external display based on a body of the user. However, the disclosure is not limited thereto.

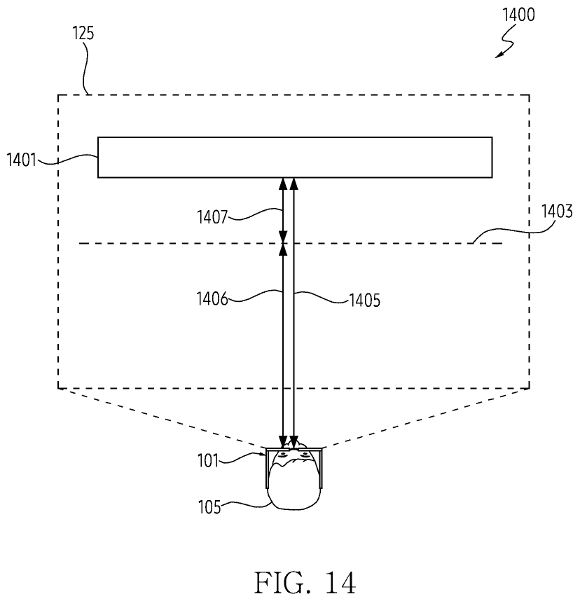

For example, the type (e.g., the utility software application) of the software application distinct from the reference type may require relatively more interaction based on the user 105 than the reference type. In a case of identifying the type of the software application distinct from the reference type, the electronic device 101 may display a screen within the three-dimensional image 125 using information (e.g., information on a size, a shape, and/or a positional relationship) on the external display relatively close to the electronic device since the relatively more interaction based on the user 105 than the reference type is required. The electronic device 101 may obtain a region for identifying the touch input to perform the interaction based on the user 105. An operation of obtaining the region will be described in greater detail below with reference to FIG. 14.

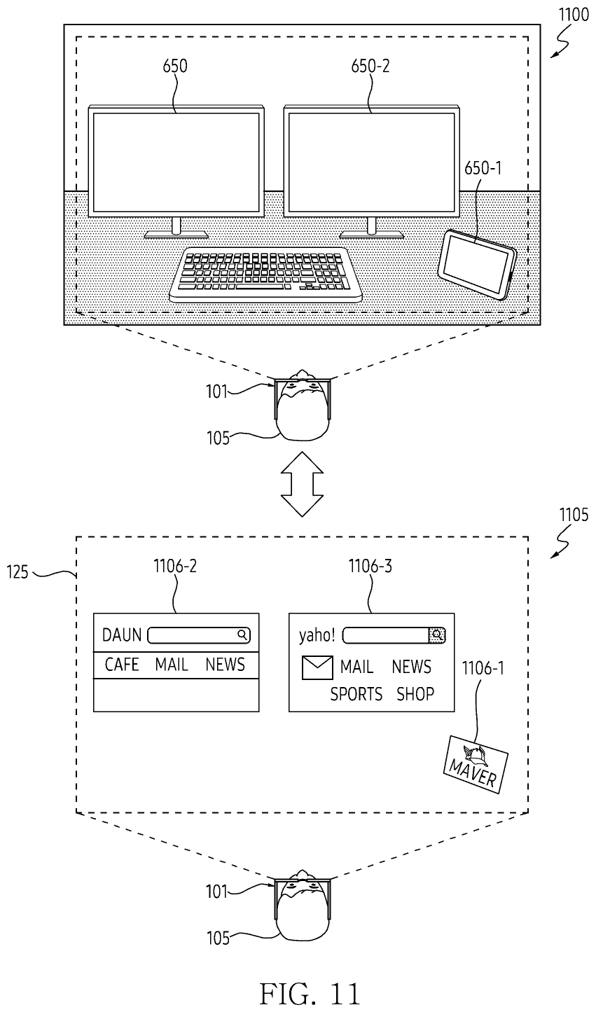

Hereinafter, an operation in which the electronic device according to an embodiment displays a plurality of screens using the plurality of external displays will be described in greater detail with reference to FIG. 11.

FIG. 11 is a diagram illustrating an example operation in which an electronic device displays a plurality of screens according to various embodiments. An electronic device 101 of FIG. 11 may be referred to the electronic device 101 of FIGS. 1 to 10.

Referring to FIG. 11, in an environment 1100, the electronic device 101 according to an embodiment may identify a plurality of external displays 650, 650-1, and 650-2 using a frame image 115. Independently of identifying the plurality of external displays 650, 650-1, and 650-2, the electronic device 101 may obtain a plurality of screens using one program (e.g., an internet software application) installed in memory.

For example, the electronic device 101 may obtain visual objects (e.g., a web tab) to distinguish each of the plurality of screens using a UI (e.g., a UI associated with internet) for the one program based on obtaining the plurality of screens. Each of the visual objects may include information (e.g., website information) indicating an execution state of one program corresponding to each of the visual objects. However, the disclosure is not limited thereto.

For example, in the environment 1100, the electronic device 101 may obtain information (e.g., a size, a shape, and/or a positional relationship) on each of the plurality of external displays 650, 650-1, and 650-2 based on receiving an input indicating a display of a three-dimensional image 125. The electronic device 101 may display each of a plurality of screens 1106-1, 1106-2, and 1106-3 in the three-dimensional image 125 using the information on each of the plurality of external displays 650, 650-1, and 650-2 in a state of obtaining the plurality of screens using the one program. As an example, in a case of identifying an external display having a size less than a preset size among a plurality of external displays, the electronic device 101 may temporarily cease generating a visual object corresponding to the external display having the size less than the preset size. However, the disclosure is not limited thereto.

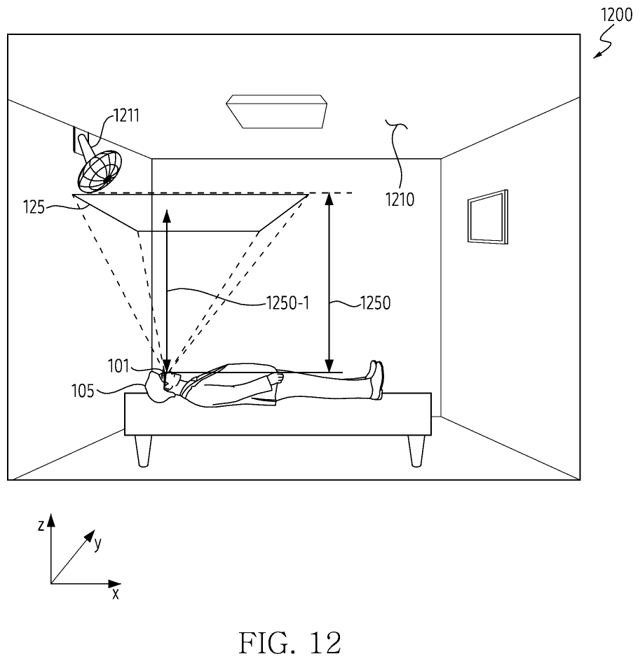

Hereinafter, referring to FIG. 12, an example of an operation in which the electronic device 101 obtains relative distance information using a sensor to display the three-dimensional image 125 (or a screen (e.g., the screen 130 of FIG. 1) associated with a three-dimensional image) on a display will be described in greater detail.

FIG. 12 is a diagram illustrating an example operation in which an electronic device displays a screen according to various embodiments. An electronic device 101 of FIG. 12 may include the electronic device 101 of FIGS. 1 to 11.

Referring to FIG. 12, the electronic device 101 according to an embodiment may detect a posture of the electronic device 101 and/or a posture of a user 105 wearing the electronic device 101 in an environment 1200 using a sensor (e.g., the sensor 460 of FIG. 4). The electronic device 101 may detect the posture of the electronic device 101 and/or the posture of the user 105 based on a direction (e.g., a z direction) perpendicular to a plane (e.g., an xy plane of FIG. 12) using the sensor. The electronic device 101 may identify a state in which the user 105 maintains a lying position based on detecting the posture of the electronic device 101 and/or the posture of the user 105 based on the direction (e.g., the z direction) perpendicular to the plane (e.g., the xy plane of FIG. 12). In the state, the electronic device 101 may use data (or cache data) stored in memory based on receiving an input indicating a display of a three-dimensional image 125. The data may include information (e.g., information on an external display or information on a plane) on a size, a shape, and/or a positional relationship used by the electronic device 101 to display the three-dimensional image 125 in another state (e.g., a state in which the electronic device 101 maintains a posture based on a direction parallel to the xy plane) distinct from the state.

For example, in a case (e.g., a case where the data is not stored in the memory) where the data is not available, the electronic device 101 may identify a ceiling 1210 using a camera. The electronic device 101 may display the three-dimensional image 125 on a display based on a size, a shape, and/or a positional relationship with respect to the ceiling 1210 based on identifying the ceiling 1210. A relative distance 1250-1 for the three-dimensional image 125 that the user 105 may detect may correspond to a distance from the electronic device 101 to the ceiling 1210.

For example, in the case (e.g., the case where the data is not stored in the memory) where the data is not available, the electronic device 101 may identify an external object 1211 using the camera. The external object 1211 may refer, for example, to an external object positioned between the electronic device 101 and the ceiling 1210. The electronic device 101 may obtain a distance 1250 between the electronic device 101 and the external object 1211. As an example, the distance 1250 may include depth information on the external object 1211. The electronic device 101 may display the screen on the display based on a size provided by a software application for displaying the three-dimensional image 125 using the distance. The relative distance 1250-1 for the screen that the user 105 of the electronic device 101 may detect may correspond to the distance 1250. However, the disclosure is not limited thereto.

As described above, the electronic device 101 according to an embodiment may display a screen associated with an augmented reality on the display using positional information on the ceiling 1210 and/or the external object 1211 independently of identifying a type of a software application for displaying the external display and/or the three-dimensional image 125 in a case where the user 105 is lying. The electronic device 101 may enhance user convenience for an augmented reality service based on displaying the screen associated with the augmented reality on the display using the positional information on the ceiling 1210 and/or the external object 1211.

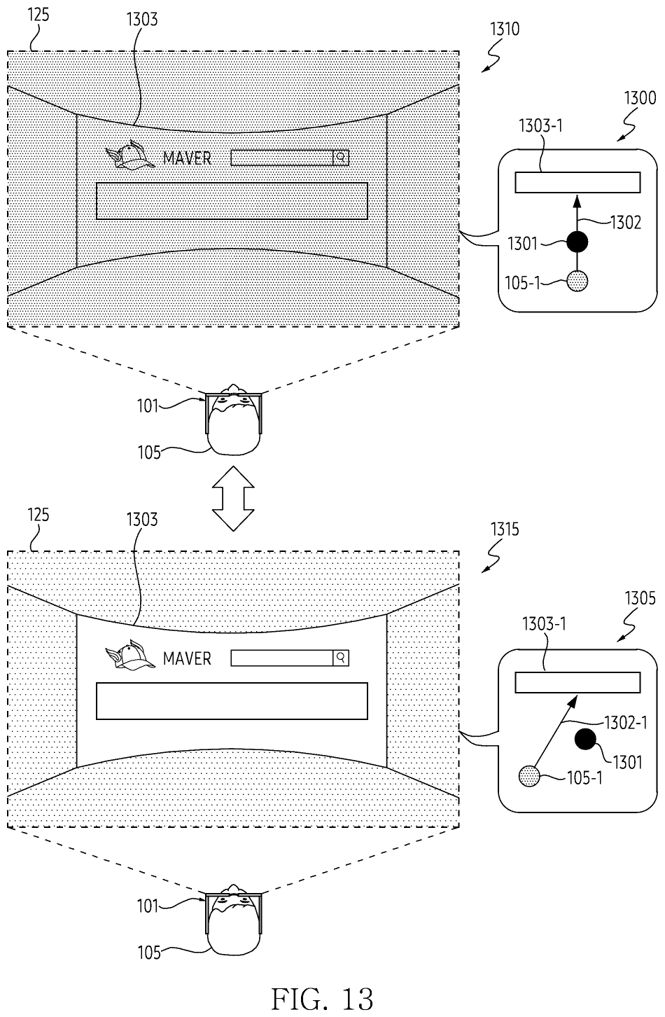

FIG. 13 is a diagram illustrating an example operation in which an electronic device guides a position change of a user according to various embodiments. An electronic device 101 of FIG. 13 may include the electronic device 101 of FIGS. 1 to 12. Referring to FIG. 13, environments 1310 and 1315 may be referred to as a virtual environment in terms of displaying a three-dimensional image 125 corresponding to at least a portion of a virtual space.

Referring to FIG. 13, the electronic device 101 according to an embodiment may display the three-dimensional image 125 and/or a screen 1303 in response to receiving an input indicating an entry into the virtual space. The electronic device 101 may obtain a position of an avatar 105-1 representing a user 105 in the virtual space while displaying the three-dimensional image 125 and/or the screen 1303. The virtual space may be accessible to a plurality of users including the user 105.

For example, in a virtual space 1300, the electronic device 101 according to an embodiment may obtain the position of the avatar 105-1 representing the user 105 and a position of an avatar 1301 representing another user. Based on obtaining the position of the avatar 105-1 representing the user 105 and the position of the avatar 1301 representing the other user, it may be identified that the avatar 1301 is positioned between the avatar 105-1 and a screen 1303-1. Based on identifying that the avatar 1301 is positioned between the avatar 105-1 and the screen 1303-1, the electronic device 101 may identify the avatar 1301 positioned within an FoV of the user 105 based on a direction 1302 from the avatar 105-1 toward the screen 1303-1. The electronic device 101 may identify that the screen 1303 is covered by the avatar 1301 based on identifying the avatar 1301 positioned within the FoV of the user 105. The electronic device 101 may guide the user 105 to change the position of the avatar 105-1 based on identifying the screen 1303 covered by the avatar 1301. The electronic device 101 may change a color for the three-dimensional image 125 including the screen 1303 to guide the user 105. An operation of changing the color for the three-dimensional image 125 by the electronic device 101 may include an operation of rendering the three-dimensional image 125 based on a gray scale. The operation of changing the color for the three-dimensional image 125 by the electronic device 101 may include an operation of setting a saturation for the three-dimensional image 125 to be relatively low. However, the disclosure is not limited thereto. As an example, the electronic device 101 may display the avatar 1301 positioned within the FoV overlapping the screen 1303 within the three-dimensional image 125. As an example, the electronic device 101 may display a visual object indicating an arrow for changing the position of the avatar 1301 on the display.

For example, the electronic device 101 may identify a position of the avatar 105-1 changed in a virtual space 1305. Based on the changed position of the avatar 105-1, it may be identified that the avatar 1301 is not positioned within the FoV based on a direction 1302-1 from the avatar 105-1 toward the screen 1303-1. The electronic device 101 may compensate for the color for the three-dimensional image 125 and/or the screen 1303 based on identifying that the screen 1303 is not covered by the avatar 1301 in the environment 1315. An operation of compensating the color for the three-dimensional image 125 and/or the screen 1303 may include an operation of using color information provided by a software application for displaying the three-dimensional image 125.

As described above, the electronic device 101 according to an embodiment may provide a more realistic augmented reality service by changing the color of the three-dimensional image 125 displayed on the display based on the position of the avatar 105-1 representing the user 105 in the virtual space.

FIG. 14 is a diagram illustrating an example operation in which an electronic device identifies a touch input according to various embodiments. An electronic device 101 of FIG. 14 may include the electronic device 101 of FIGS. 1 to 13. Referring to FIG. 14, an environment 1400 may be referred to as a virtual environment in terms of displaying a three-dimensional image 125 on a display.

The electronic device 101 according to an embodiment may display a screen 1401 within the three-dimensional image 125 using a distance 1405 to an external display (e.g., the external display 150 of FIG. 1) obtained using a frame image (e.g., the frame image 115 of FIG. 1) in the environment 1400. The electronic device 101 may obtain a touch input region 1403 for identifying interaction between the screen 1401 and a user 105. The touch input region 1403 may be obtained using a distance 1407 shorter than the distance 1405 between the electronic device 101 and the external display corresponding to the screen 1401. The touch input region 1403 may be obtained based on a position spaced apart from the screen 1401 or the external display corresponding to the screen 1401 by the preset distance 1407. For example, the electronic device 101 may identify an input indicating selection of at least one multimedia content included in the screen 1401 corresponding to the touch input region 1403. The preset distance 1407 may be set based on a size of the at least one multimedia content. For example, the electronic device 101 may identify the input based on identifying a body part (e.g., a hand) of the user 105 positioned in the touch input region 1403 using a camera. However, the disclosure is not limited thereto.

FIG. 15 is a flowchart illustrating an example operation of an electronic device according to various embodiments. At least one of operations of FIG. 15 may be performed by the electronic device 101 of FIG. 4 and/or the processor 420 of FIG. 4. Each of the operations of FIG. 15 may be performed sequentially, but is not necessarily performed sequentially. For example, an order of each of the operations may be changed, and at least two operations may be performed in parallel. At least one of the operations of FIG. 15 may be associated with at least one of the operations of FIG. 5.

Referring to FIG. 15, in operation 1510, the electronic device according to an embodiment may identify a visual object corresponding to an external display (e.g., the external display 150 of FIG. 1) in an environment based on obtaining a frame image (e.g., the frame image 115 of FIG. 1) corresponding to at least a portion of the environment (e.g., the environment 110 of FIG. 1) around the electronic device through a camera.

Referring to FIG. 15, in operation 1520, the electronic device according to an embodiment may receive an input indicating a display of a three-dimensional image (e.g., the three-dimensional image 125 of FIG. 1) by replacing the frame image displayed through a display. For example, the electronic device may perform the operation 1510 after performing the operation 1520. For example, the electronic device may initiate execution of a software application for displaying the three-dimensional image based on receiving the input. The electronic device may temporarily cease displaying the frame image displayed on the display and initiate displaying the three-dimensional image.

Referring to FIG. 15, in operation 1530, the electronic device according to an embodiment may identify a type of the software application for the display of the three-dimensional image. The type of the software application may include a multimedia software application (e.g., the multimedia software application 435 of FIG. 4) and a utility software application (e.g., the utility software application 432).

Referring to FIG. 15, in operation 1540, the electronic device according to an embodiment may confirm whether a type of a software application corresponding to a reference type has been identified. Referring to FIG. 15, in a case that the type of the software application corresponding to the reference type is identified (the operation 1540-YES), in operation 1550, the electronic device according to an embodiment may display a first screen having a size provided by the software application in the three-dimensional image based on a positional relationship between the electronic device and the external display. The positional relationship may include a distance (e.g., the distance 117 of FIG. 1) between the electronic device and the external display. The positional relationship may include a relative position of the external display with respect to the electronic device.

Referring to FIG. 15, in a case that a type of a software application distinct from the reference type is identified (the operation 1550-NO), in operation 1560, the electronic device according to an embodiment may display a second screen having a size of a visual object identified based on the positional relationship between the electronic device and the external display within the three-dimensional image. The positional relationship may include the distance (e.g., the distance 117 of FIG. 1) between the electronic device and the external display. The positional relationship may include the relative position of the external display with respect to the electronic device. The electronic device may obtain a position, a shape, and/or a size of a screen to be displayed within the three-dimensional image based on obtaining a shape and/or a size of the external display through the frame image. However, the disclosure is not limited to the example described above.

Metaverse is a compound word of the English words “Meta” meaning “virtual” and “transcendence” and “Universe” meaning cosmos, and refers to a three-dimensional virtual world in which social, economic, and cultural activities take place like a real world. Metaverse may refer to a concept that has evolved one step further than a virtual reality (VR, cutting-edge technology that enables people to experience real-life experiences in a virtual world created by a computer), and it is characterized using avatars to not only enjoy games or virtual reality, but also social and cultural activities like a reality. A metaverse service may provide media content for enhancing immersion in the virtual world, based on an augmented reality (AR), a virtual reality environment (VR), a mixed environment (MR), and/or an extended reality (XR).

For example, media content provided by the metaverse service may include social interaction content including avatar-based game, concert, party, and/or meeting. For example, the media content may include information for economic activities such as advertising, user created content, and/or sales and/or shopping of productions. Ownership of the user created content may be proved by a blockchain-based non-fungible token (NFT). The metaverse service may support economic activities based on real money and/or cryptocurrency. By the metaverse service, virtual content associated with the real world, such as digital twin or life logging, may be provided.

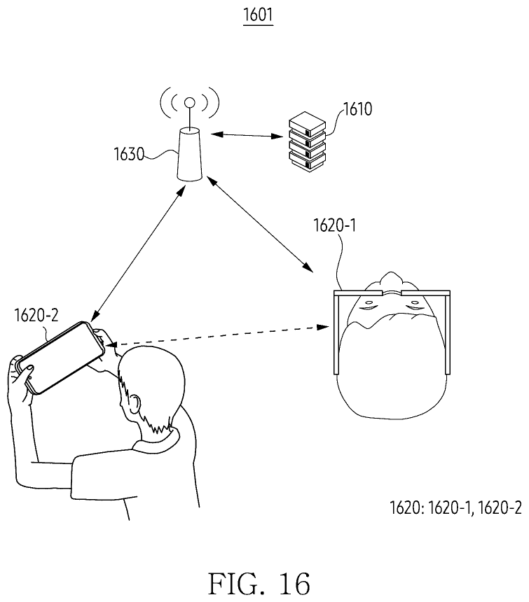

FIG. 16 is a diagram illustrating an example network environment 1601 in which a metaverse service is provided through a server 1610 according to various embodiments.

Referring to FIG. 16, a network environment 1601 may include a server 1610, a user terminal 1620 (e.g., a first terminal 1620-1 and a second terminal 1620-2), and a network connecting the server 1610 and the user terminal 1620. In the network environment 1601, the server 1610 may provide a metaverse service to the user terminal 1620. The network may be formed by at least one intermediate node 1630 including an access point (AP) and/or a base station. The user terminal 1620 may access the server 1610 through the network and output a user interface (UI) associated with a metaverse service to a user of the user terminal 1620. Based on the UI, the user terminal 1620 may obtain information to be inputted into the metaverse service from the user, or output information (e.g., multimedia content) associated with the metaverse service to the user.

In this case, the server 1610 provides a virtual space so that the user terminal 1620 may perform activities in the virtual space. In addition, the user terminal 1620 may represent information provided by the server 1610 to the user by installing an S/W agent to access the virtual space provided by the server 1610, or transmit information that the user wants to represent in the virtual space to the server. The S/W agent may be provided directly through the server 1610, downloaded from a public server, or embedded and provided when purchasing a terminal.

In an embodiment, the metaverse service may provide a service to the user terminal 1620 and/or a user using the server 1610. The disclosure is not limited thereto, and the metaverse service may be provided through individual contacts between users. For example, in the network environment 1601, the metaverse service may be provided by a direct connection between the first terminal 1620-1 and the second terminal 1620-2, independently of the server 1610. Referring to FIG. 16, in the network environment 1601, the first terminal 1620-1 and the second terminal 1620-2 may be connected to each other through a network formed by at least one intermediate node 1630. In an embodiment in which the first terminal 1620-1 and the second terminal 1620-2 are directly connected, any one of the first terminal 1620-1 and the second terminal 1620-2 may perform a role of the server 1610. For example, a metaverse environment may be configured only with a device-to-device connection (e.g., a peer-to-peer (P2P) connection).

In an embodiment, the user terminal 1620 (or the user terminal 1620 including the first terminal 1620-1 and the second terminal 1620-2) may be made in various form factors, and it is characterized by including an output device for providing an image and/or sound to the user and an input device for inputting information into the metaverse service. An example user terminal 1620 in various form factors may include a smartphone (e.g., the second terminal 1620-2), an AR device (e.g., the first terminal 1620-1), a VR device, an MR device, a Video See Through (VST) device, an Optical See Through (OST) device, a smart lens, a smart mirror, a TV capable of inputting and outputting, or a projector.

A network (e.g., a network formed by at least one intermediate node 1630) includes all of various broadband networks including 3G, 4G, and 5G and short-range networks (e.g., a wired network or a wireless network that directly connects the first terminal 1620-1 and the second terminal 1620-2) including Wi-Fi and BT. The user terminal 1620 may be referred to the electronic device 101 of FIG. 1.

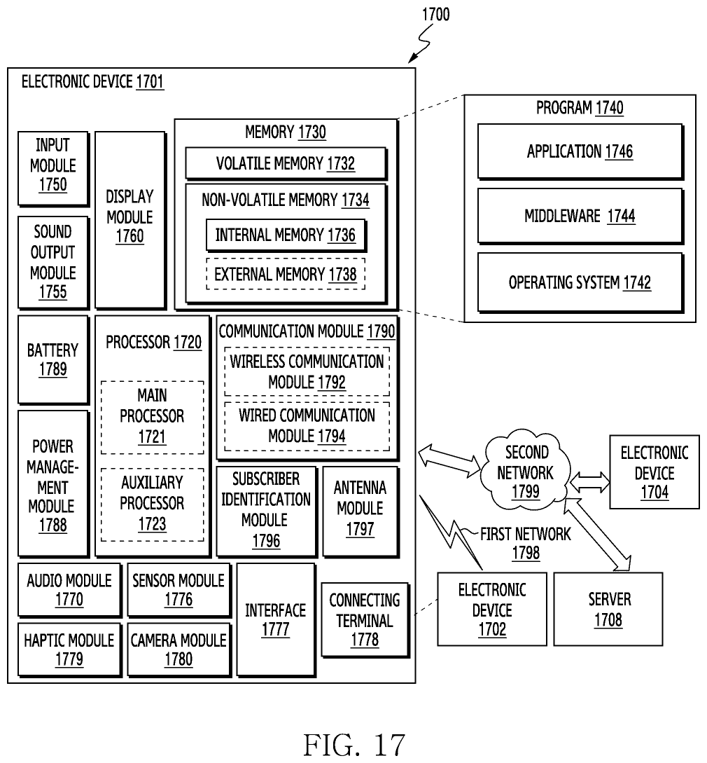

FIG. 17 is a block diagram illustrating an example electronic device 1701 in a network environment 1700 according to various embodiments. Referring to FIG. 17, the electronic device 1701 in the network environment 1700 may communicate with an electronic device 1702 via a first network 1798 (e.g., a short-range wireless communication network), or at least one of an electronic device 1704 or a server 1708 via a second network 1799 (e.g., a long-range wireless communication network). According to an embodiment, the electronic device 1701 may communicate with the electronic device 1704 via the server 1708. According to an embodiment, the electronic device 1701 may include a processor 1720, memory 1730, an input module 1750, a sound output module 1755, a display module 1760, an audio module 1770, a sensor module 1776, an interface 1777, a connecting terminal 1778, a haptic module 1779, a camera module 1780, a power management module 1788, a battery 1789, a communication module 1790, a subscriber identification module (SIM) 1796, and/or an antenna module 1797. In various embodiments, at least one of the components (e.g., the connecting terminal 1778) may be omitted from the electronic device 1701, or one or more other components may be added in the electronic device 1701. In various embodiments, some of the components (e.g., the sensor module 1776, the camera module 1780, or the antenna module 1797) may be implemented as a single component (e.g., the display module 1760).

The processor 1720 may execute, for example, software (e.g., a program 1740) to control at least one other component (e.g., a hardware or software component) of the electronic device 1701 coupled with the processor 1720, and may perform various data processing or computation. According to an embodiment, as at least part of the data processing or computation, the processor 1720 may store a command or data received from another component (e.g., the sensor module 1776 or the communication module 1790) in volatile memory 1732, process the command or the data stored in the volatile memory 1732, and store resulting data in non-volatile memory 1734. According to an embodiment, the processor 1720 may include a main processor 1721 (e.g., a central processing unit (CPU) or an application processor (AP)), or an auxiliary processor 1723 (e.g., a graphics processing unit (GPU), a neural processing unit (NPU), an image signal processor (ISP), a sensor hub processor, or a communication processor (CP)) that is operable independently from, or in conjunction with, the main processor 1721. For example, when the electronic device 1701 includes the main processor 1721 and the auxiliary processor 1723, the auxiliary processor 1723 may be adapted to consume less power than the main processor 1721, or to be specific to a specified function. The auxiliary processor 1723 may be implemented as separate from, or as part of the main processor 1721. Thus, the processor 1720 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 1723 may control at least some of functions or states related to at least one component (e.g., the display module 1760, the sensor module 1776, or the communication module 1790) among the components of the electronic device 1701, instead of the main processor 1721 while the main processor 1721 is in an inactive (e.g., sleep) state, or together with the main processor 1721 while the main processor 1721 is in an active state (e.g., executing an application). According to an embodiment, the auxiliary processor 1723 (e.g., an image signal processor or a communication processor) may be implemented as part of another component (e.g., the camera module 1780 or the communication module 1790) functionally related to the auxiliary processor 1723. According to an embodiment, the auxiliary processor 1723 (e.g., the neural processing unit) may include a hardware structure specified for artificial intelligence model processing. An artificial intelligence model may be generated by machine learning. Such learning may be performed, e.g., by the electronic device 1701 where the artificial intelligence is performed or via a separate server (e.g., the server 1708). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1730 may store various data used by at least one component (e.g., the processor 1720 or the sensor module 1776) of the electronic device 1701. The various data may include, for example, software (e.g., the program 1740) and input data or output data for a command related thereto. The memory 1730 may include the volatile memory 1732 or the non-volatile memory 1734.

The program 1740 may be stored in the memory 1730 as software, and may include, for example, an operating system (OS) 1742, middleware 1744, or an application 1746.

The input module 1750 may receive a command or data to be used by another component (e.g., the processor 1720) of the electronic device 1701, from the outside (e.g., a user) of the electronic device 1701. The input module 1750 may include, for example, a microphone, a mouse, a keyboard, a key (e.g., a button), or a digital pen (e.g., a stylus pen).

The sound output module 1755 may output sound signals to the outside of the electronic device 1701. The sound output module 1755 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1760 may visually provide information to the outside (e.g., a user) of the electronic device 1701. The display module 1760 may include, for example, a display, a hologram device, or a projector and control circuitry to control a corresponding one of the display, hologram device, and projector. According to an embodiment, the display module 1760 may include a touch sensor adapted to detect a touch, or a pressure sensor adapted to measure the intensity of force incurred by the touch.

The audio module 1770 may convert a sound into an electrical signal and vice versa. According to an embodiment, the audio module 1770 may obtain the sound via the input module 1750, or output the sound via the sound output module 1755 or a headphone of an external electronic device (e.g., an electronic device 1702) directly (e.g., wiredly) or wirelessly coupled with the electronic device 1701.

The sensor module 1776 may detect an operational state (e.g., power or temperature) of the electronic device 1701 or an environmental state (e.g., a state of a user) external to the electronic device 1701, and then generate an electrical signal or data value corresponding to the detected state. According to an embodiment, the sensor module 1776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1777 may support one or more specified protocols to be used for the electronic device 1701 to be coupled with the external electronic device (e.g., the electronic device 1702) directly (e.g., wiredly) or wirelessly. According to an embodiment, the interface 1777 may include, for example, a high definition multimedia interface (HDMI), a universal serial bus (USB) interface, a secure digital (SD) card interface, or an audio interface.

A connecting terminal 1778 may include a connector via which the electronic device 1701 may be physically connected with the external electronic device (e.g., the electronic device 1702). According to an embodiment, the connecting terminal 1778 may include, for example, an HDMI connector, a USB connector, an SD card connector, or an audio connector (e.g., a headphone connector).

The haptic module 1779 may convert an electrical signal into a mechanical stimulus (e.g., a vibration or a movement) or electrical stimulus which may be recognized by a user via his tactile sensation or kinesthetic sensation. According to an embodiment, the haptic module 1779 may include, for example, a motor, a piezoelectric element, or an electric stimulator.

The camera module 1780 may capture a still image or moving images. According to an embodiment, the camera module 1780 may include one or more lenses, image sensors, image signal processors, or flashes.

The power management module 1788 may manage power supplied to the electronic device 1701. According to an embodiment, the power management module 1788 may be implemented as at least part of, for example, a power management integrated circuit (PMIC).

The battery 1789 may supply power to at least one component of the electronic device 1701. According to an embodiment, the battery 1789 may include, for example, a primary cell which is not rechargeable, a secondary cell which is rechargeable, or a fuel cell.

The communication module 1790 may support establishing a direct (e.g., wired) communication channel or a wireless communication channel between the electronic device 1701 and the external electronic device (e.g., the electronic device 1702, the electronic device 1704, or the server 1708) and performing communication via the established communication channel. The communication module 1790 may include one or more communication processors that are operable independently from the processor 1720 (e.g., the application processor (AP)) and supports a direct (e.g., wired) communication or a wireless communication. According to an embodiment, the communication module 1790 may include a wireless communication module 1792 (e.g., a cellular communication module, a short-range wireless communication module, or a global navigation satellite system (GNSS) communication module) or a wired communication module 1794 (e.g., a local area network (LAN) communication module or a power line communication (PLC) module). A corresponding one of these communication modules may communicate with the external electronic device via the first network 1798 (e.g., a short-range communication network, such as Bluetooth™, wireless-fidelity (Wi-Fi) direct, or infrared data association (IrDA)) or the second network 1799 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1792 may identify and authenticate the electronic device 1701 in a communication network, such as the first network 1798 or the second network 1799, using subscriber information (e.g., international mobile subscriber identity (IMSI)) stored in the subscriber identification module 1796.

The wireless communication module 1792 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1792 may support a high-frequency band (e.g., the mm Wave band) to achieve, e.g., a high data transmission rate. The wireless communication module 1792 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1792 may support various requirements specified in the electronic device 1701, an external electronic device (e.g., the electronic device 1704), or a network system (e.g., the second network 1799). According to an embodiment, the wireless communication module 1792 may support a peak data rate (e.g., 20 Gbps or more) for implementing eMBB, loss coverage (e.g., 1764 dB or less) for implementing mMTC, or U-plane latency (e.g., 0.5 ms or less for each of downlink (DL) and uplink (UL), or a round trip of 17 ms or less) for implementing URLLC.

The antenna module 1797 may transmit or receive a signal or power to or from the outside (e.g., the external electronic device) of the electronic device 1701. According to an embodiment, the antenna module 1797 may include an antenna including a radiating element including a conductive material or a conductive pattern formed in or on a substrate (e.g., a printed circuit board (PCB)). According to an embodiment, the antenna module 1797 may include a plurality of antennas (e.g., array antennas). In such a case, at least one antenna appropriate for a communication scheme used in the communication network, such as the first network 1798 or the second network 1799, may be selected, for example, by the communication module 1790 (e.g., the wireless communication module 1792) from the plurality of antennas. The signal or the power may then be transmitted or received between the communication module 1790 and the external electronic device via the selected at least one antenna. According to an embodiment, another component (e.g., a radio frequency integrated circuit (RFIC)) other than the radiating element may be additionally formed as part of the antenna module 1797.

According to various embodiments, the antenna module 1797 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1701 and the external electronic device 1704 via the server 1708 coupled with the second network 1799. Each of the electronic devices 1702 or 1704 may be a device of a same type as, or a different type, from the electronic device 1701. According to an embodiment, all or some of operations to be executed at the electronic device 1701 may be executed at one or more of the external electronic devices 1702, 1704, or 1708. For example, if the electronic device 1701 should perform a function or a service automatically, or in response to a request from a user or another device, the electronic device 1701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1701. The electronic device 1701 may provide the outcome, with or without further processing of the outcome, as at least part of a reply to the request. To that end, a cloud computing, distributed computing, mobile edge computing (MEC), or client-server computing technology may be used, for example. The electronic device 1701 may provide ultra low-latency services using, e.g., distributed computing or mobile edge computing. In an embodiment, the external electronic device 1704 may include an internet-of-things (IoT) device. The server 1708 may be an intelligent server using machine learning and/or a neural network. According to an embodiment, the external electronic device 1704 or the server 1708 may be included in the second network 1799. The electronic device 1701 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1740) including one or more instructions that are stored in a storage medium (e.g., internal memory 1736 or external memory 1738) that is readable by a machine (e.g., the electronic device 1701). For example, a processor (e.g., the processor 1720) of the machine (e.g., the electronic device 1701) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added. The electronic device 1701 of FIG. 17 may be referred to the electronic device 101 of FIG. 1.

After displaying a frame image indicating at least a portion of a reality environment, an electronic device according to an embodiment may maintain continuity between the reality environment and a virtual environment based on displaying a three-dimensional image indicating at least a portion of the virtual environment. A method in which the electronic device uses an external display to maintain the continuity between the reality environment and the virtual environment may be required.

An electronic device according to an example embodiment as described above may include a display 450, a camera 440, at least one processor 420 including processing circuitry, and memory 430 including one or more storage mediums, storing instructions. The instructions, when executed by the at least one processor individually or collectively, may cause the electronic device to, based on obtaining a frame image 115 corresponding to at least a portion of an environment 110, 600, 610, 630, 640, 700, 710, 720, 820, 830, 1000, 1100, or 1200 around the electronic device through the camera, identify a visual object corresponding to an external display 150 in the environment. The instructions, when executed by the at least one processor individually or collectively, may cause the electronic device to receive an input indicating a display of a three-dimensional image 125 by replacing the frame image displayed through the display. The instructions, when executed by the at least one processor individually or collectively, may cause the electronic device to identify a type of a software application 432 or 435 for the display of the three-dimensional image based on receiving the input. The instructions, when executed by the at least one processor individually or collectively, may cause the electronic device to, in a case of identifying the type corresponding to a reference type, based on a positional relationship between the electronic device and the external display, display a first screen having a size provided by the software application within the three-dimensional image. The instructions, when executed by the at least one processor individually or collectively, may cause the electronic device to, in a case of identifying the type distinct from the reference type, display, within the three-dimensional image, a second screen having a size of the visual object identified based on the positional relationship between the electronic device and the external display.

For example, to display the second screen within the three-dimensional image, the instructions, when executed by the at least one processor individually or collectively, may cause the electronic device to, using the camera, obtain the positional relationship based on identifying, a direction from the electronic device towards the external display and a distance 117 between the electronic device and the external display. The instructions, when executed by the at least one processor individually or collectively, may cause the electronic device to display the second screen at a position corresponding to the positional relationship within the three-dimensional image.

For example, to obtain the positional relationship, the instructions, when executed by the at least one processor individually or collectively, may cause the electronic device to identify the distance between the electronic device and the external display based on identifying a depth distance for the visual object within the frame image.

For example, to display the second screen within the three-dimensional image, the instructions, when executed by the at least one processor individually or collectively, may cause the electronic device to display the second screen corresponding to a shape of the visual object. For example, to display the second screen within the three-dimensional image, the instructions, when executed by the at least one processor individually or collectively, may cause the electronic device to identify a first edge 150-1 and a second edge 150-2 of the visual object based on the shape of the visual object. The instructions, when executed by the at least one processor individually or collectively, may cause the electronic device to display the second screen within the three-dimensional image based on one edge 706-1 of the second screen corresponding to the first edge. The second edge may be shorter than the first edge.

For example, to display the second screen within the three-dimensional image, the instructions, when executed by the at least one processor individually or collectively, may cause the electronic device to identify each of a plurality of visual objects corresponding to each of a plurality of external electronic devices 650, 650-1, 650-2, and 650-3 including the external display. The instructions, when executed by the at least one processor individually or collectively, may cause the electronic device to display, within the three-dimensional image, the second screen having the size of the visual object that is the largest among sizes of each of the plurality of visual objects.

For example, to display the second screen within the three-dimensional image, the instructions, when executed by the at least one processor individually or collectively, may cause the electronic device to identify another visual object corresponding to another external electronic device 650-2 or 650-3, distinct from the external display, among the plurality of visual objects, based on displaying the second screen. The instructions, when executed by the at least one processor individually or collectively, may cause the electronic device to display a third screen 1012 or 1013 having another size of the other visual object overlapping at least a portion of the second screen. The other size corresponding to the other external electronic device may be smaller than the size of the visual object.

For example, the instructions, when executed by the at least one processor individually or collectively, may cause the electronic device to identify an input indicating selection of at least one multimedia content included within the first screen or the second screen, using a touch input distance 1406 shorter than the distance, based on identifying the distance 1405 between the electronic device and the external display using the camera.

In a method performed by an electronic device 101 according to an embodiment as described above, the method may include, while identifying a visual object corresponding to an external display 150 in an environment using a frame image 115 corresponding to at least a portion of the environment 110, 600, 610, 630, 640, 700, 710, 720, 820, 830, 1000, 1100, or 1200 around the electronic device using a camera 440, receiving an input indicating a display of a three-dimensional image through a display 450. The method may include identifying a type of a software application 432 or 435 for the display of the three-dimensional image based on receiving the input. The method may include, in a case of identifying the type corresponding to a reference type, based on a positional relationship between the electronic device and the external display, displaying a first screen having a size provided by the software application within the three-dimensional image. The method may include, in a case of identifying the type distinct from the reference type, displaying, within the three-dimensional image, a second screen having a size of the visual object identified based on the positional relationship between the electronic device and the external display.

For example, the displaying the second screen within the three-dimensional image may include, using the camera, obtaining the positional relationship based on identifying, a direction from the electronic device towards the external display and a distance 117 between the electronic device and the external display. The displaying the first screen within the three-dimensional image may include displaying the second screen at a position corresponding to the positional relationship within the three-dimensional image.

For example, the obtaining the positional relationship may include identifying the distance between the electronic device and the external display based on identifying a depth distance for the visual object within the frame image.

For example, the displaying the second screen within the three-dimensional image may include displaying the second screen corresponding to a shape of the visual object.

For example, the displaying the second screen within the three-dimensional image may include identifying a first edge 150-1 and a second edge 150-2 of the visual object based on the shape of the visual object. The displaying the second screen within the three-dimensional image may include displaying the second screen within the three-dimensional image based on one edge 706-1 of the second screen corresponding to the first edge. The second edge may be shorter than the first edge.

For example, the displaying the second screen within the three-dimensional image may include identifying each of a plurality of visual objects corresponding to each of a plurality of external electronic devices 650, 650-1, 650-2, and 650-3 including the external display. The displaying the second screen within the three-dimensional image may include displaying, within the three-dimensional image, the second screen having the size of the visual object that is the largest among sizes of each of the plurality of visual objects.

For example, the displaying the second screen within the three-dimensional image may include identifying another visual object corresponding to another external electronic device 650-2 or 650-3, distinct from the external display, among the plurality of visual objects, based on displaying the second screen. The displaying the second screen within the three-dimensional image may include displaying a third screen 1012 or 1013 having another size of the other visual object overlapping at least a portion of the second screen. The other size corresponding to the other external electronic device may be smaller than the size of the visual object.

In a non-transitory computer-readable storage medium storing one or more programs including instructions according to an example embodiment as described above, the one or more programs, when executed by at least one processor 420 of an electronic device 101 including a display and a camera individually or collectively, may cause the electronic device to, while identifying a visual object corresponding to an external display 150 in the environment using a frame image 115 corresponding to at least a portion of an environment 110, 600, 610, 630, 640, 700, 710, 720, 820, 830, 1000, 1100, or 1200 around the electronic device using a camera 440, receive an input indicating a display of a three-dimensional image 125 through a display 450. The one or more programs, when executed by the at least one processor of the electronic device including a display and a camera individually or collectively, may cause the electronic device to identify a type of a software application 432 or 435 for the display of the three-dimensional image based on receiving the input. The one or more programs, when executed by the at least one processor of the electronic device including a display and a camera individually or collectively, may cause the electronic device to, in a case of identifying the type corresponding to a reference type, based on a positional relationship between the electronic device and the external display, display a first screen having a size provided by the software application within the three-dimensional image. The one or more programs, when executed by the at least one processor of the electronic device including a display and a camera individually or collectively, may cause the electronic device to include instructions causing the electronic device to, in a case of identifying the type distinct from the reference type, display, within the three-dimensional image, a second screen having a size of the visual object identified based on the positional relationship between the electronic device and the external display.

For example, to display the second screen within the three-dimensional image, the one or more programs, when executed by at least one processor of an electronic device including a display and a camera individually or collectively, may cause the electronic device to, using the camera, obtain the positional relationship based on identifying, a direction from the electronic device towards the external display and a distance 117 between the electronic device and the external display. The one or more programs may cause the electronic device to include instructions, when executed by at least one processor of an electronic device including a display and a camera individually or collectively, causing the electronic device to display the second screen at a position corresponding to the positional relationship within the three-dimensional image.

For example, to obtain the positional relationship, the one or more programs may cause the electronic device to include instructions, when executed by at least one processor of an electronic device including a display and a camera individually or collectively, causing the electronic device to identify the distance between the electronic device and the external display based on identifying a depth distance for the visual object within the frame image.

For example, to display the second screen within the three-dimensional image, the one or more programs may cause the electronic device to include instructions, when executed by at least one processor of an electronic device including a display and a camera individually or collectively, causing the electronic device to display the second screen corresponding to a shape of the visual object.

For example, to display the second screen within the three-dimensional image, the one or more programs may cause the electronic device to, when executed by at least one processor of an electronic device including a display and a camera individually or collectively, identify a first edge 150-1 and a second edge 150-2 of the visual object based on the shape of the visual object. The one or more programs may cause the electronic device to include instructions, when executed by at least one processor of an electronic device including a display and a camera individually or collectively, causing the electronic device to display the second screen within the three-dimensional image based on one edge 706-1 of the second screen corresponding to the first edge. The second edge may be shorter than the first edge.

In an electronic device 101 according to an embodiment as described above, the electronic device may include a display 450, a camera 440, and a processor 420. Instructions, when executed by the at least one processor individually or collectively, may cause the electronic device to execute a software application 432 or 435 for a three-dimensional image 125 to be additionally displayed on the display after receiving an input indicating that a display of a frame image 115 obtained through the camera is to be ceased. The instructions, when executed by the at least one processor individually or collectively, may cause the electronic device to, in a case where a type of the software application is a first type, display, within the three-dimensional image, a first screen having a size provided by the software application. The processor may be configured to, in a case where the type is a second type, display, within the three-dimensional image, a second screen having a size of a visual object included in the frame image and identified based on a positional relationship between the electronic device and an external display 150.

In a method performed by an electronic device according to an example embodiment as described above, the method may include executing a software application for a three-dimensional image to be additionally displayed on a display after receiving an input indicating that a display of a frame image obtained through a camera is to be ceased. The method may include, in a case where a type of the software application is a first type, displaying, within the three-dimensional image, a first screen having a size provided by the software application. The method may include, in a case where the type is a second type, displaying, within the three-dimensional image, a second screen having a size of a visual object included in the frame image and identified based on a positional relationship between the electronic device and an external display.

In an electronic device 101 according to an example embodiment as described above, the electronic device may be configured to include a display 450, a camera 440, and a processor 420. The processor, may be configured to receive an input for executing a software application 432 or 435 while displaying a frame image 115 obtained through the camera. The processor may be configured to, in response to the input, initiate execution of the software application to display, on the display, a three-dimensional image 125. The processor may be configured to, in a case where a type of the executed software application is a first type, display, within the three-dimensional image, a first screen having a size provided by the software application. The processor may be configured to, in a case where the type is a second type, display, within the three-dimensional image, a second screen having a size of a visual object included in the frame image and identified based on a positional relationship between the electronic device and an external display 150.

In a method performed by an electronic device 101 according to an example embodiment as described above, the method may include, while displaying a frame image 115 obtained through a camera, receiving an input for executing a software application 432 or 435. The method may include, in response to the input, initiating execution of the software application to display, on a display, a three-dimensional image 125. The method may include, in a case where a type of the executed software application is a first type, displaying, within the three-dimensional image, a first screen having a size provided by the software application. The method may include, in a case where the type is a second type, displaying, within the three-dimensional image, a second screen having a size of a visual object included in the frame image and identified based on a positional relationship between the electronic device and an external display 150.

In a non-transitory computer-readable storage medium storing one or more programs according to an example embodiment as described above, the one or more programs may be configured to include instructions, when executed by at least one processor 420 of an electronic device 101 including a display and a camera individually or collectively, causing the electronic device to, while representing a frame image 115 obtained through a camera, receive an input to execute a software application 432 and 435. The one or more programs may be configured to include instructions, when executed by at least one processor of an electronic device including a display and a camera individually or collectively, causing the electronic device to, in response to the input, initiate execution of the software application to display, on a display, a three-dimensional image 125. The one or more programs may be configured to include instructions, when executed by at least one processor of an electronic device including a display and a camera individually or collectively, causing the electronic device to, in a case where a type of the executed software application is a first type, display, within the three-dimensional image, a first screen having a size provided by the software application. The one or more programs may be configured to include instructions, when executed by at least one processor of an electronic device including a display and a camera individually or collectively, causing the electronic device to, in a case where the type is a second type, display, within the three-dimensional image, a second screen having a size of a visual object included in the frame image and identified based on a positional relationship between the electronic device and an external display 150.

The device described above may be implemented as a hardware component, a software component, and/or a combination f a hardware component and a software component. For example, the devices and components described in the disclosure may be implemented using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the disclosure may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although various example embodiments have been described above with reference to various examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved. It will also be understood that any of the embodiment(s) described herein may be used in conjunction with any other embodiment(s) described herein.

Therefore, other implementations, other embodiments, and those equivalent to the scope of the claims are in the scope of the disclosure, including the appended claims and their equivalents.

What is claimed is:

1. An electronic device comprising:
a display;
a camera;
at least one processor comprising processing circuitry; and
memory comprising one or more storage mediums, storing instructions,
wherein at least one processor individually or collectively, is configured to execute the instructions and to cause the electronic device to:
while displaying a frame image obtained through the camera, receive an input for executing a software application,
in response to the input, initiate execution of the software application to display, on the display, a three-dimensional image,
based on a type of the executed software application being a first type, display, within the three-dimensional image, a first screen having a size provided by the software application, and
based on the type of the executed software application being a second type, display, within the three-dimensional image, a second screen having a size of a visual object included in the frame image and identified based on a positional relationship between the electronic device and an external display.

2. The electronic device of claim 1,
wherein, to display the second screen within the three-dimensional image, at least one processor individually or collectively, is configured to cause the electronic device to:
using the camera, obtain the positional relationship based on identifying, a direction from the electronic device towards the external display and a distance between the electronic device and the external display, and
display the second screen at a position corresponding to the positional relationship within the three-dimensional image.

3. The electronic device of claim 2,
wherein at least one processor individually or collectively, cause the electronic device to:
identify the distance between the electronic device and the external display based on identifying a depth distance for the visual object corresponding to the external display within the frame image.

4. The electronic device of claim 1,
wherein at least one processor individually or collectively, is configured to cause the electronic device to:
display the second screen corresponding to a shape of the visual object.

5. The electronic device of claim 1,
wherein at least one processor individually or collectively, is configured to cause the electronic device to:
identify a first edge and a second edge of the visual object based on the shape of the visual object, and
display the second screen within the three-dimensional image based on one edge of the second screen corresponding to the first edge, and
wherein the second edge is shorter than the first edge.

6. The electronic device of claim 1,
wherein, to display the second screen within the three-dimensional image, at least one processor individually or collectively, is configured to cause the electronic device to:
identify, using the camera, each of a plurality of visual objects corresponding to each of a plurality of external electronic devices including the external display, and
display, within the three-dimensional image the second screen having the size of the visual object that is largest among sizes of each of the plurality of visual objects.

7. The electronic device of claim 6,
wherein at least one processor individually or collectively, is configured to cause the electronic device to:
identify another visual object corresponding to another external electronic device, distinct from the external display, among the plurality of visual objects, based on displaying the second screen, and
display a third screen having another size of the another visual object overlapping at least a portion of the second screen, and
wherein the another size corresponding to the another external electronic device is smaller than the size of the visual object.

8. The electronic device of claim 1,
wherein at least one processor individually or collectively, is configured to cause the electronic device to:
identify an input indicating selection of at least one multimedia content included within the first screen or the second screen, using a touch input distance shorter than the distance, based on identifying the distance between the electronic device and the external display using the camera.

9. A method performed by an electronic device comprising:
while displaying a frame image obtained through a camera, receiving an input for executing a software application,
in response to the input, initiating execution of the software application to display, on a display, a three-dimensional image,
based on a type of the executed software application being a first type, displaying, within the three-dimensional image, a first screen having a size provided by the software application, and
based on the type of the executed software application being a second type, displaying, within the three-dimensional image, a second screen having a size of a visual object included in the frame image and identified based on a positional relationship between the electronic device and an external display.

10. The method of claim 9,
wherein displaying the second screen within the three-dimensional image comprises:
using the camera, obtaining the positional relationship based on identifying, a direction from the electronic device towards the external display and a distance between the electronic device and the external display, and
displaying the second screen at a position corresponding to the positional relationship within the three-dimensional image.

11. The method of claim 10,
wherein obtaining the positional relationship comprises:
identifying the distance between the electronic device and the external display based on identifying a depth distance for the visual object corresponding to the external display within the frame image.

12. The method of claim 9,
wherein displaying the second screen within the three-dimensional image comprises:
displaying the second screen corresponding to a shape of the visual object.

13. The method of claim 9,
wherein displaying the second screen within the three-dimensional image comprises:
identifying a first edge and a second edge of the visual object based on the shape of the visual object, and
displaying the second screen within the three-dimensional image based on one edge of the second screen corresponding to the first edge, and
wherein the second edge is shorter than the first edge.

14. The method of claim 9,
wherein displaying the second screen within the three-dimensional image comprises:
identifying, using the camera, each of a plurality of visual objects corresponding to each of a plurality of external electronic devices including the external display, and
displaying, within the three-dimensional image the second screen having the size of the visual object that is largest among sizes of each of the plurality of visual objects.

15. A non-transitory computer-readable storage medium storing one or more programs including instructions which, when executed by at least one processor, comprising processing circuitry, of an electronic device including a display and a camera individually or collectively, cause the electronic device to:
while displaying a frame image obtained through the camera, receive an input for executing a software application,
in response to the input, initiate execution of the software application to display, on the display, a three-dimensional image,
based on a type of the executed software application being a first type, display, within the three-dimensional image, a first screen having a size provided by the software application, and
based on the type of the executed software application being a second type, display, within the three-dimensional image, a second screen having a size of a visual object included in the frame image and identified based on a positional relationship between the electronic device and an external display.

16. The non-transitory computer-readable storage medium of claim 15,
wherein the instructions, when executed by at least one processor of the electronic device individually or collectively, cause the electronic device to:
using the camera, obtain the positional relationship based on identifying, a direction from the electronic device towards the external display and a distance between the electronic device and the external display, and
display the second screen at a position corresponding to the positional relationship within the three-dimensional image.

17. The non-transitory computer-readable storage medium of claim 16,
wherein the instructions, when executed by at least one processor of the electronic device individually or collectively, cause the electronic device to:
identify the distance between the electronic device and the external display based on identifying a depth distance for the visual object corresponding to the external display within the frame image.

18. The non-transitory computer-readable storage medium of claim 15,
wherein the instructions, when executed by at least one processor of the electronic device individually or collectively, cause the electronic device to:
display the second screen corresponding to a shape of the visual object.

19. The non-transitory computer-readable storage medium of claim 15,
wherein the instructions, when executed by at least one processor of the electronic device individually or collectively, cause the electronic device to:
identify a first edge and a second edge of the visual object based on the shape of the visual object, and
display the second screen within the three-dimensional image based on one edge of the second screen corresponding to the first edge, and
wherein the second edge is shorter than the first edge.

20. The non-transitory computer-readable storage medium of claim 15,
wherein the instructions, when executed by at least one processor of the electronic device individually or collectively, cause the electronic device to:
identify, using the camera, each of a plurality of visual objects corresponding to each of a plurality of external electronic devices including the external display, and
display, within the three-dimensional image the second screen having the size of the visual object that is largest among sizes of each of the plurality of visual objects.
